(19) United States
(12) Patent Application Publication
(10) Pub. No.: US 2009/0150169 A1
(43) Pub. Date: Jun. 11, 2009

(54) Document acquisition and authentication system

(75) Inventors: Carter Kirkwood, Pacific Palisades, CA (US); Misha Gridnev, Boulder Creek, CA (US)

Correspondence Address: LIU & LIU, 444 S. FLOWER STREET SUITE 1750, LOS ANGELES, CA, 90071, US

(73) Assignee: Unlimited CAD Services, LLC

(21) Appl. No.: 12/284,610

(22) Filed: Sep. 22, 2008

Related U.S. Application Data
(63) Continuation-in-part of application No. 11/750,178, filed on May 17, 2007.
(60) Provisional application No. 60/994,767, filed on Sep. 21, 2007.
(60) Provisional application No. 61/009,388, filed on Dec. 28, 2007.

(51) Int. Cl. G06Q 99/00

(52) U.S. Cl. 705/1

(57) ABSTRACT

A document acquisition and authentication system comprising a web-based application that on behalf of its users can automatically: a) collect Digital Documents, b) create standardized descriptive metadata related to each Digital Document, c) use that descriptive metadata to organize, sort, and filter the collected Digital Documents, d) collect and create evidence that third party users can use to judge the authenticity of particular Digital Documents, e) protect the users privacy during the collection, storage, and sharing of the Digital Documents. The web-based application provides users with functionalities including user management, Source management, automatic and manual document acquisition, and document management and sharing. The System can receive Digital Documents that users manually upload into it and it enables users to manually enter standardized descriptive metadata. The System can then automatically handle the other functions for the Digital Documents.

### CROSS REFERENCE TO RELATED APPLICATIONS

This application claims the priority of Provisional Patent Application No. 60/994,767, which was filed Sep. 21, 2007 and Provisional Patent Application No. 61/009,388, which was filed Dec. 28, 2007. This application is a continuation-in-part application of U.S. patent application Ser. No. 11/750,178. These earlier applications and all patent documents and other publications disclosed herein below are fully incorporated by reference, as if fully set forth herein.

### BACKGROUND OF THE INVENTION

1. Field of the Invention

The present invention generally relates to information access and distribution, and in particular to techniques for the access and distribution of authenticated sensitive private information, such as financial and medical information.

2. Description of Related Art

The prior U.S. patent application Ser. No. 11/750,178 (US 2008/0005024 A1) (which is commonly assigned to the assignee of the present application) has been fully incorporated by reference herein. (Any discrepancy between the disclosure herein and the prior disclosure is deemed to be directed to improvements and/or embodiments beyond the earlier disclosure.) The earlier application discloses a document management system that operates the rights and control of the author of a document, such as a financial institution reporting financial information to a client front the rights and control over the document contents of the owner of the document, such as the client of the financial institution whose information is being presented. The document owner controls distribution of the document to desired users, such as a mortgage broker or a tax accountant, but without the ability to change the contents or at least without the ability to do so without the ability to make changes without detection. As a result, the author may provide the owner with a document that the owner can cause to be received by a desired user or other recipient while maintaining the authentication of the document by the issuing author, for example, the financial institution. The privacy and security of the data contents may be protected by encryption. The author may encrypt the document and the owner may select recipients to receive the decryption key, for example, via a website

It would be advantageous to provide an application to facilitate users to manually or automatically acquire, manage, store and index documents, data, and metadata, and to share these items with authenticity and user privacy protections.

### SUMMARY OF THE INVENTION

The present invention improves on the system disclosed in the earlier application. The present invention is directed to a document acquisition and authentication system that comprises a network-based application (e.g., software implemented processes and functions) that on behalf of its users can automatically: a) collect Digital Documents, b) create standardized descriptive metadata related to each Digital Document, c) use that descriptive metadata to organize, sort, and filter the collected Digital Documents, d) collect and create evidence that third party users can use to judge the authenticity of particular Digital Documents, e) protect the users privacy during the collection, storage, and sharing of the Digital Documents. More specifically the web-based application of the System provides users with functionalities including user management, Source management, automatic and manual document acquisition, and document management and sharing.

The disclosed System is also able to receive Digital Documents that users manually upload into it and it enables users to manually enter standardized descriptive metadata. For manually uploaded documents the disclosed System can then automatically a) use that descriptive metadata to organize, sort, and filter the uploaded Digital Documents, b) collect and create evidence that third party users can use to judge the authenticity of the uploaded Digital Documents, c) protect the user's privacy during the uploading, storage, and sharing of the Digital Documents.

In one embodiment, the System operates over the Internet, wherein the user interface application is a web-based application.

### BRIEF DESCRIPTION OF THE DRAWINGS

For a fuller understanding of the scope and nature of the invention, reference should be made to the following detailed description read in conjunction with the accompanying drawings.

FIG. 1 is a block diagram illustrating the user management function in accordance with one embodiment of the present invention.

FIG. 2 is a block diagram illustrating the document acquisition function in accordance with one embodiment of the present invention.

FIG. 3 is a block diagram illustrating the document management function in accordance with one embodiment of the present invention.

FIG. 4 illustrates the My Folders tree page in accordance with one embodiment of the present invention.

FIG. 5 illustrates a document list for a user's folder page in accordance with one embodiment of the present invention.

FIG. 6 illustrates the document management page in accordance with one embodiment of the present invention.

FIG. 7 is a block diagram illustrating the verified contact of the contact management process in accordance with one embodiment of the present invention.

FIG. 8 illustrates the home page for the System's Web site in accordance with one embodiment of the present invention.

FIG. 9 illustrates the Manage Folders page in accordance with one embodiment of the present invention.

FIG. 10 is a block diagram illustrating sharing folder names function in accordance with one embodiment of the present invention.

FIG. 11 is a block diagram illustrating sharing an added folder name function in accordance with one embodiment of the present invention.

FIG. 12 is a block diagram illustrating deleting a shared folder name function in accordance with one embodiment of the present invention.

FIG. 13 is a block diagram illustrating unsharing folder names function in accordance with one embodiment of the present invention.

FIG. 14 is a web page illustrates how users search for documents in accordance with one embodiment of the present invention.

FIG. 15 is a block diagram illustrating acquiring a new version of a previously acquired document function in accordance with one embodiment of the present invention.

FIG. 16 is a block diagram illustrating automatic check list (year-to-year) function in accordance with one embodiment of the present invention.

FIG. 17 is a block diagram illustrating automatic check list (received statements) function in accordance with one embodiment of the present invention.

FIG. 18 is a block diagram illustrating automatic forwarding process in accordance with one embodiment of the present invention.

FIG. 19 is a block diagram illustrating automatic forwarding with approval process in accordance with one embodiment of the present invention.

FIG. 20 is a block diagram illustrating third-party request process.

FIG. 21 is a block diagram illustrating third-party request of system folder function in accordance with one embodiment of the present invention.

FIG. 22 is a block diagram illustrating third-party search and request function in accordance with one embodiment of the present invention.

FIG. 23 is a block diagram illustrating capital gains planning function in accordance with one embodiment of the present invention.

FIG. 24 is a block diagram illustrating integration with other software packages in accordance with one embodiment of the present invention.

FIG. 25 is a block diagram illustrating automatic to-do list function in accordance with one embodiment of the present invention.

FIG. 25 is a block diagram illustrating statement auditing function in accordance with one embodiment of the present invention.

FIG. 27 is a block diagram illustrating superimposed dynamic content function in accordance with one embodiment of the present invention.

FIG. 28 is a block diagram illustrating replaced dynamic content function, hash on static content only in accordance with one embodiment of the present invention.

FIG. 29 is a block diagram illustrating replaced dynamic content function, hash on entire document in accordance with one embodiment of the present invention.

FIG. 30 illustrates the Documents to Share/Revoke pane in accordance with one embodiment of the present invention.

FIG. 31 is a block diagram illustrating manual redaction with contextual data function in accordance with one embodiment of the present invention.

FIG. 32 is a block diagram illustrating automatic redaction function in accordance with one embodiment of the present invention.

FIG. 33 is a block diagram illustrating default redaction function in accordance with one embodiment of the present invention.

FIG. 34 is a block diagram illustrating manual redaction with no contextual data function in accordance with one embodiment of the present invention.

FIG. 35 is a block diagram illustrating document-class redaction function in accordance with one embodiment of the present invention.

FIG. 36 is a block diagram illustrating default redaction rer document class function in accordance with one embodiment of the present invention.

FIG. 37 is a block diagram illustrating document ownership transfer function in accordance with one embodiment of the present invention.

FIG. 38 is a block diagram illustrating decryption function in accordance with one embodiment of the present invention.

FIG. 39 is a schematic diagram of an exemplary computing environment in which aspects of the invention may be implemented.

### DETAILED DESCRIPTION OF EMBODIMENTS OF THE INVENTION

The present description is of the best presently contemplated mode of carrying out the invention. This description is made for the purpose of illustrating the general principles of the invention and should not be taken in a limiting sense. The scope of the invention is best determined by reference to the appended claims.

The detailed descriptions of the process of the present invention are presented in terms of schematics, functional components, methods or processes, symbolic or schematic representations of operations, functionalities and features of the invention. These descriptions and representations are the means used by those skilled in the art to most effectively convey the substance of their work to others skilled in the art. A software implemented function, method or process is here, and generally, conceived to be a self-consistent sequence of steps leading to a desired result. These steps require physical manipulations of physical quantities. Often, but not necessarily, these quantities take the form of electrical or magnetic signals capable of being stored, transferred, combined, compared, and otherwise manipulated by associated hardware and firmware.

Useful devices for performing the software implemented processes, operations and functions of the present invention include, but are not limited to, general or specific purpose digital processing and/or computing devices, which devices may be standalone devices or part of a larger system. These devices may be selectively activated or reconfigured by a program, routine and/or a sequence of instructions and/or logic stored in the devices to undertake the disclosed functions, processes and operations. In short, use of the processes, functions and operations described and suggested herein is not limited to a particular processing configuration.

For purposes of illustrating the principles of the present invention and not by limitation, the present invention is described herein below by reference to an exemplary system. However, it is understood that the present invention is equally applicable to systems of other configurations embodying the invention, without departing from the scope and spirit of the present invention.

Exemplary Computing Environment

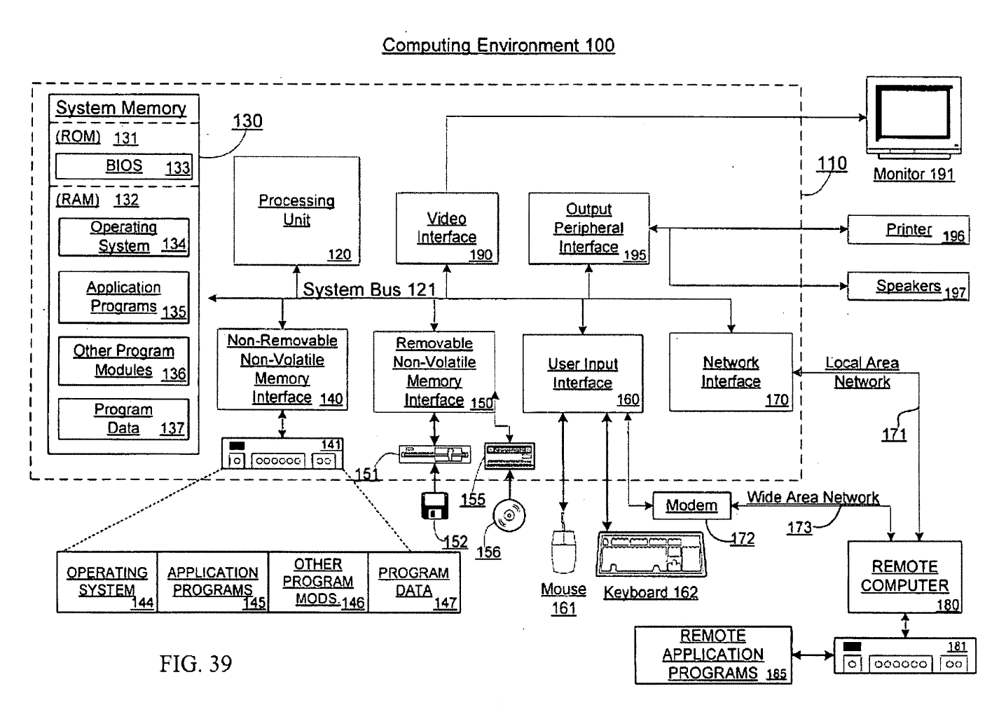

FIG. 39 shows an exemplary computing environment in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types, including the networked based (e.g., web-based) application of the System described herein below. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 39, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. Communication media typically embodies computer readable instructions, data structures, program modules or other data in a modulated data signal (i.e., a signal that has one or more of its characteristics set or changed in such a manner as to encode information in the signal) such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 39 illustrates operating system 134, application programs 135, other program modules 136, and program data 137.

The computer 110 may also include other removable/non-removable, volatile/nonvolatile computer storage media. By way of example only, FIG. 39 illustrates a hard disk drive 141, a magnetic disk drive 151 that reads/writes a removable magnetic disk 152, and an optical disk drive 155 that reads/writes a removable optical disk 156, such as a CD ROM or other optical media. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 39, provide storage of computer readable instructions, data structures, program modules and other data for the computer 110. In FIG. 39, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 39. The logical connections depicted in FIG. 39 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 39 illustrates remote application programs 185 as residing on memory device 181. It will be appreciated that the network connections shown are exemplary and other means of establishing a communications link between the computers may be used.

The network-based application of the System may be implemented in one or more servers, computers, etc., in the environment shown in FIG. 39.

Glossary of Terms

The following list serves as a point of reference for terms used in the present application.

Acquired File—a file consisting a combination of Digital Document and Related metadata, in particular: Source name, Document Date, Acquisition Date, Originator name, Owner name, hash result. In the described embodiment herein, the application has all six metadata items, but other applications could have a smaller subset of metadata. An Acquired File may also contain other data discussed in this disclosure.

Application Server—That part of the System that accepts requests and commands from users and serves documents and other information to users. In some embodiments, the Application Server handles encryption and decryption tasks as well.

Automatic Document Acquisition Module (ADAM)—The software implement components that make up ADAM collect Digital Documents and information about Digital Documents (document metadata) from Sources, such as institutions' websites.

Authenticity Evidence—Data that is related to a particular Digital Document that is relevant to whether or not a particular document is authentic and which can be taken into consideration by a System user in his or her deciding if they believe a particular Digital Document is authentic. With respect to any particular Digital Document the System collects and stores the following: Integrity Evidence, the name of that Digital Document's Source, and that Document's Acquisition Date.

Contact—A Contact is a registered user of the System with whom another user can share Acquired Files. Contacts are maintained in users' address books. A Contact may also be referred to as a Recipient, Sender, or sharing partner.

Contextual Data—Contextual Data is a machine-readable representation of the information in a Digital Document. Contextual data typically adheres to one of a number of formats based on Extensible Markup Language (XML), such as the Open Financial Exchange (OFX) format or the U.S. Internal Revenue Service's standard XML format. Other institution- or industry-specific XML formats may be used as well.

Credentials—Credentials are tokens that are presented to the System to gain access to a resource. A common form of credentials is a user name and password pair.

Descriptive Metadata Extraction (DME)—DME consists of software implemented components which extract document metadata from Digital Documents and/or Source's websites.

Digital Document—A Digital Document is the digital representation of information that can be presented to users as a document, such as an Adobe PDF, Microsoft Word, Microsoft Excel, GIF, or HTML file.

Acquisition Date—The date on which a particular Digital Document first entered the System, either by automatic acquisition or manual upload.Document Date—The Document Data is the date on the actual document, also referred as the official date on a particular Digital Document or the date the document was created. An example of a Document Date would be a bank statement date or the effective date of a contract.

Integrity Evidence—This term refers to evidence indicating that a document has not been altered since the Acquisition Date.

Originator—The Originator is the individual or entity that created a Digital Document or that is likely to be perceived to be the creator of a particular Digital Document. The Originator's name is used for organizing, filtering, and sorting Digital Documents. As a potential contrast, see also Source and Owner.

Owner—The Owner is the individual or entity that owns certain rights in a Digital Document and/or has effective control over a document. An example of these kinds of rights would be a user's privacy rights in his or her financial and medical records. As a potential contrast, see also Source and Originator.

Recipient—The Recipient is the individual or entity with whom the document Sender intends to share a document. The Recipient is also referred to as a Contact or sharing partner once the Recipient becomes a registered user of the System.

Sender—In the process of document sharing, the document Sender is the document Owner in a state where he/she wishes to share a document with a Recipient.

Source—The Source is the individual or entity that last had control of a document just before the document was acquired by the System. The Source data is used for providing document integrity evidence about a related Digital Document. As a potential contrast, see also Originator and Owner. The Source is the individual or entity that was the last party to have control of the document before it entered into the System, as evidenced by, without limitation, any of the following: (a) a user's System credentials; (b) URL information for a location where the postings of documents is controlled by a known entity or individual; and (c) a secure communication channel that only a particular entity or individual has access to. A Source, Owner, and Originator may or may not be the same person or entity. For example, a Source financial institution from which the System obtains Digital Documents directly will also be the Originator for those documents. However, if Person 1 scans a paper document from a given financial institution and uploads the resulting Digital Document into the System, the Originator will be that financial institution, but Person I will be the Source and the Owner. In another scenario, a third party could scan documents from a financial institution and upload them into the System on behalf of Person 1. In this case, the Source (the third party), the Originator (the financial institution), and the Owner (Person 1) are all different entities.

System—The disclosed system as a whole comprising the disclosed functions and features herein; the System consists of software implemented modules and processes and associated hardware.

Administrative Metadata—Information used to manage the object or control access to it. For example, administrative metadata could include how the Digital Document was scanned, its storage format, an copyright Ownership information.

Structural Metadata—It ties each object to others to make up logical units. Structural metadata can enable single Source publishing and flexible display of content. For example, structural metadata could relate individual images of pages from a book to the others that make up the book or could track that the same content is used in multiple documents.

Descriptive Metadata—It describes the intellectual content of the associated object. Descriptive metadata is typically used for bibliographic purposes and for search and retrieval. For example, knowing that a particular document is a contract and its effective date could be used to quickly find that particular contract among many other documents.

System Overview

The illustrated embodiment of the System comprises a web-based software implemented process that is designed to provide its users with a means of collecting, managing, and sharing documents while preserving confidentiality.

From a user's perspective, the System provides the following functionality:

1. User registers and logs into the System's website.

2. User configures his/her profile to acquire documents from Sources; for example, a user might configure his profile to collect bank accounts from a financial institution. Configuring the profile involves providing the System with information about the accounts a user holds at an institution, such as the credentials used to log into the institution's website.

3. User configures the System to schedule automatic document acquisition at specific intervals, or to collect the documents manually when the user asks the System to do so. The System determines the appropriate schedule to automatically, periodically, collect documents on the user's behalf. The user can initiate document collection manually whenever he/she visits the System's website. In an alternative embodiment, the user could override the System-determined collection schedule by selecting a time frequency (including, without limitation, daily, weekly, and monthly) with which the System should attempt to collect documents from a given Source.

4. Once the documents are collected, the user can use the System's website to view documents easily in one central location, as well as share them with other users, such as their accountants.

5. When documents are shared, document Recipients can obtain information about the document that can helps them verify the authenticity of the document, such as how long the document has been in the System, confirmation that the document has remained unaltered while in the System, and who originally created the document.

From a process perspective, the System has software implemented functional components that provide users with the following functionality:

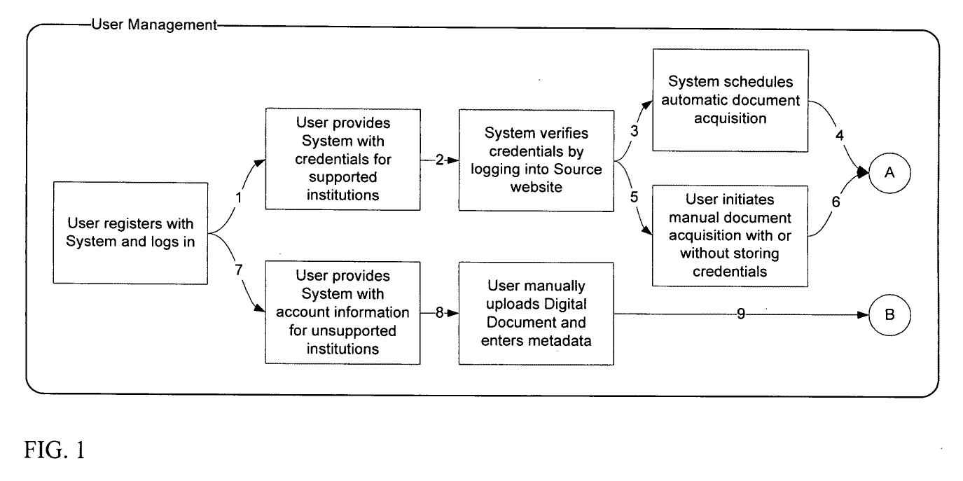

1. User management (see FIG. 1): The System has components that handle user registration and logins into the System's website. The System can verify a user's phone and e-mail information by sending an e-mail with unique information a user must use to access the System and calling a specified number with an authentication code which the user then must enter in the System to verify his or her access to that phone number.

2. Source management: The System enables users to store credentials for Sources. For example, if a user has an account at River Bank, and has online banking, the user can store the login information in the System. The System stores this information in a way so that the information can later be used to collect documents from the Source automatically at intervals set by the user. The Source management component is designed to log into the user's Source account and to handle challenge questions and security codes with which the Source may respond.

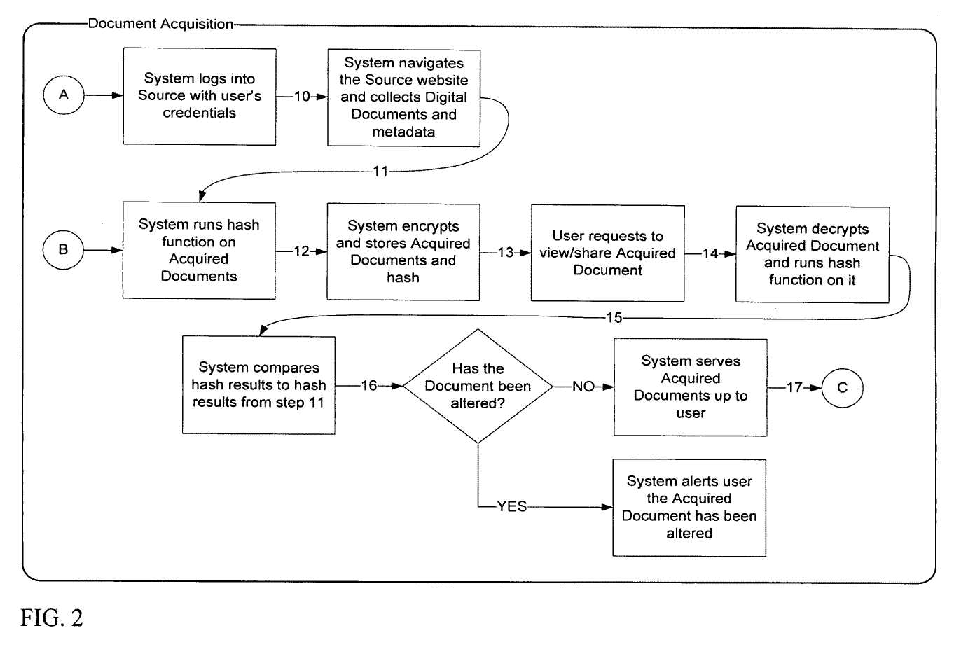

3. Automatic and manual document acquisition (see FIG. 2): Automatic document acquisition is handled by the Automatic Document Acquisition Module (ADAM). ADAM includes software implemented components that can collect Digital Documents and information related to those Digital Documents (metadata) from Sources. ADAM can use the credentials stored during the user management process to log into Sources' websites. It can navigate the Sources' websites, locate Digital Documents, extract metadata, and copy the information to the System's data store; all without user intervention. Users can configure the System to schedule ADAM to collect documents at specific intervals. Because ADAM's navigational and collection components rely heavily on the then current layout, structure, and format of each Source's website, these components will need to be updated whenever relevant changes are made to the layout, structure, and/or format of any Source website. Regular monitoring and updating by the System's development and quality assurance staff is important for ongoing functional availability. Manual document upload can be done by each user. The user can use the System website to upload a digital representation of a paper document.

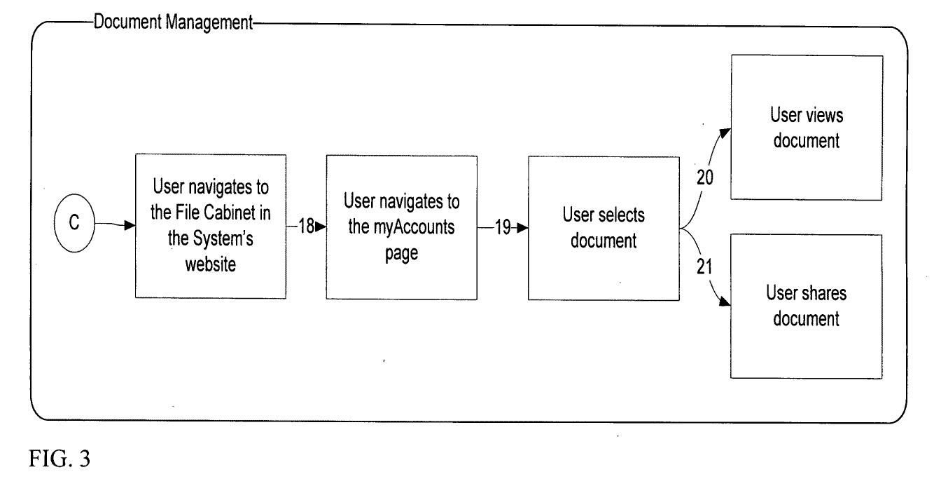

4. Document management and sharing (see FIG. 3): The System provides users with the ability to view and sort documents. In addition, the System enables users to share documents amongst one another. This process involves mechanisms by which the System requires the Sender and the Recipient of shared documents to be mutually authenticated to maintain confidentiality of the documents. The Contact creation process is described in “Contact Management” later below.

Metadata

Metadata Taxonomy

The disclosed invention's metadata taxonomy includes administrative, structural, and descriptive types of metadata. The definitions for most, if not all, of the Metadata Taxonomy are made available to users of the System so they can understand how to use the metadata to find things, determine authenticity of a document, protect their privacy, and reuse data.

Administrative Metadata

The disclosed invention includes Administrative metadata that enables its users to manage what individuals or entities have access to particular documents. Administrative metadata is collected, stored, and presented to users as evidence related to the authenticity of a document. The disclosed administrative metadata taxonomy includes the following types of metadata:

1. Source
a. The invention tracks the Source using unique identification for each Source.
b. It is used for providing evidence about the party that last had control of a particular document before it was added to the System. This evidence is intended to assist users in determining if a particular document is authentic.
c. Examples include without limitation:
   i. Bank of America
   ii. Joe Smith (or any other individual's name)
d. Citibank,
e. E*Trade,
f. Kaiser,
g. AT&T Wireless

2. Owner
a. Used granting control or management of certain rights and access to documents in the System.
b. Examples include without limitation:
   i. Joe Smith (or any other individual's name)
c. Jim Baker, Trustee (or any other individual's name who acts as a trustee for a legal trust)
d. Joe's Café, LLC (or any other legal entity which owns trade secret rights in a document)
e. Jane Smith, book keeper (or any other agent who the legal Owner has delegated the authority to control his or her privacy rights)

3. Acquisition Date
a. Used as a degree of authenticity; the longer a document has been in the System, the more trusted a user may perceive it to be.

Descriptive Metadata

It is possible to organize a large set of documents in an almost infinite number of ways. The disclosed invention includes a descriptive metadata taxonomy that enables the efficient and intuitive use by non professionals of record keeping System that include without limitation financial, legal, and medical records. The disclosed descriptive metadata taxonomy includes the following hierarchy:

1. Originator
a. Examples include without limitation:
   i. Bank of America,
   ii. Citibank,
   iii. E*Trade,
   iv. Kaiser,
   v. AT&T Wireless,
   vi. Mary's Café, LLC.

2. Account Number
a. Defined as numeric or textual way of tracking different accounts or clients of any Source.
b. Used for tracking and distinguishing documents from one or more accounts that a customer may have with a particular Source
c. Examples include without limitation:
   i. 020217-62114
   ii. K7d9em3
   iii. N/A (for not applicable)

3. Document Date
a. Defined as the official date of a document or the date upon which a designated action occurred. The date format can be selected by the user.
b. Examples include without limitation:
   i. The particular date that a check was deposited,
   ii. The particular date that a check was cleared,
   iii. The particular date that a contract was signed, and
   iv. The particular date that a contract became effective.

4. Document Type
a. Defined as the legal type of document or an industries' term for a type of document.
b. Examples include without limitation:
   i. Statement,
   ii. Check,
   iii. Trade Confirmation,
   iv. Invoice,
   v. Annual Report,
   vi. Prospectus,
   vii. W2,
   viii. 1099,
   ix. 1098,
   x. Tax Return,
   xi. Diagnostic Test Result, and
   xii. Other.

5. Account Type
i. Defined as the legal type of account or an industries' term for a type of account.
ii. Examples include without limitation:
iii. Checking,
iv. Savings,
v. Brokerage,
vi. Credit Card,
vii. Mortgage,
viii. Car Loan,
ix. Phone,
x. Insurance,
xi. Cable,
xii. Cell Phone,
xiii. Other, and
xiv. N/A (for not applicable)

6. Date a document is shared

7. A document Sender's name

8. A document Recipient's name

Custom Metadata

In addition to the administrative and descriptive metadata associated with a given document, users can define and use custom metadata of their own design. Such custom metadata is manifested in the ability to create and manage custom folders (see “Managing Folders” discussed later below). Custom metadata is for a user's benefit only; unlike descriptive and administrative metadata, custom metadata cannot be used by third party users.

Evolution of Metadata

Over time it is expected that some metadata definitions will be added, deleted, combined, split, renamed and otherwise modified. For example, this is necessary because certain tax and SEC document definitions change on a regular basis. This also enables terms that have been created through the folksonomy process to be added to the formal taxonomy. The System accommodates this by having different metadata taxonomies associated with particular years. If for example a particular metadata type is deleted from the System, that would mean it could no longer be applied to new documents, but existing documents would continue to retain the original metadata associated with it.

User's Ability to Change Metadata Associated with a Particular Document

There is a range of how easily users of the System can change metadata associated with a particular document (and in some cases they cannot change it at all). For example, users can not change Authentication evidence (including the Source name, the hash result, and the Acquisition date). By contrast the inclusion of a document in a custom folder can be changed easily by a user. As another example, the System can track and audit user changes to Originator information. Over time, the level of ease with which certain metadata can be changed can evolve to become easier or more difficult.

Metadata Creation

The administrative and descriptive metadata can be created in one or more of three ways: Collection from Source, Creation by Source, and Creation by Owner.

Collection from Source

In this method, metadata is derived or inferred from information made available by a Source, for example, on a Source's Web site or Web application. For more information on this method, see “Descriptive Metadata Acquisition” discussed later below.

Creation By Source

In this method, metadata is directly supplied by or acquired from a Source in some standard format. (See “Secure Peer-To-Peer Connection” discussed later below.)

Creation By Owner

In this method, a digital document is uploaded to the System by the Owner, who also supplies the appropriate metadata (by using the System's user interface, by uploading a separate file in a standard format, or by some other means). For more information on this method, see “Manual Document Upload” discussed later below.

Metadata Usage By Third parties

The administrative and descriptive metadata associated with a document can be used by third parties with whom a document is shared (see “Sharing Documents” discussed later below), for example, for filtering and sorting of shared documents.

Sample Scenario

In this disclosure, the System employs a centralized document acquisition methodology. In this methodology, document acquisition, metadata acquisition and extraction, as well as the storage and sharing of documents is all performed at the server level rather than on users' local computers. In this centralized embodiment, the System is the central point to which users connect to view and share documents. The Source may also connect to the System to push documents into the System. Encryption, decryption, and document integrity verification occurs at the central location as well.

The following is a sample scenario that illustrates the use of the System:

1. A user has several accounts at financial institutions and wants to be able to view and share the financial documents from a single location. To be able to do so, the user registers with the System.

2. The user logs into her System account and configures her profile to store the login information for the financial institutions. The System connects to the financial institution's website and enters the login information to verify the credentials. The System has the user provide challenge question answers and security codes if a financial institution requests those for login.

3. Once the credentials are verified, the System stores them and uses them for document acquisition.

4. The user configures the System to obtain her financial documents automatically at a specified interval.

5. Per the configured schedule, the System uses ADAM to acquire new Digital Documents and any other relevant data. ADAM then extracts the relevant data and translates it into the appropriate metadata form, runs the hash function, encrypts the Digital Document, and stores the metadata, hash, and Digital Document in the appropriate parts of the System's storage.

6. The System creates accounts and assigns the appropriate Digital Documents to the accounts.

7. The user can now view the Digital Documents from the System's website and can share them with other System users, such as her tax accountant. The user can also assign documents to existing folders or organize the documents using custom folders.

8. The user wants to share her documents with her tax account, and has the System prepare an invitation to the accountant, which includes the tax accountant's phone number and email address.

9. If the user has not yet verified her phone number, the System prompts the user to verify her phone number.

10. The user can modify the phone number provided during the registration process. The user requests the System to calls the provided number with an authentication code.

11. The user enters the authentication code in the System.

12. The System verifies if the entered code matches the code sent to the user's phone. If the codes match, the System sends an invitation to the accountant's email address. If the codes do not match, the System prompts the user to try again.

13. The tax accountant clicks the link in the email.

14. The System displays a page asking the accountant to log into the System to accept the invitation.

15. If the accountant is not yet a registered user, the System has the accountant go through the registration process.

16. The accountant logs into the System to view the invitation.

17. The Systems prompts the accountant to verify his phone number to confirm his identity.

18. The accountant requests the System to send an authentication code to the phone number provided by the user.

19. The System calls the tax accountant's phone number with an authentication code.

20. The tax accountant enters the authentication code in the System.

21. If the code is correct, the System completes the invitation process. If the code does not match, the System prompts the accountant to try again.

22. The tax accountant can now view the Acquired Document. The user and the tax accountant added to each other's address book for future sharing of documents.

The following are sample scenarios of how various forms of metadata interact with the rest of the System:

1. John Smith creates a letter and uploads that letter into the System. In this case, John Smith is the Originator, Source, and Owner of the letter.

2. River Bank creates a monthly statement. Customer A uses the System to automatically collect that monthly statement from River Bank's web site. In this case, River Bank is the Originator and the Source of that monthly statement. Customer A is the Owner of that monthly statement.

3. Mary has an old monthly statement from Global Bank stored in her filing cabinet. Mary takes that monthly statement and scans it into her personal computer and uploads it onto the System. In this case, Global Bank is the Originator and Mary is both the Source and Owner of that monthly statement.

4. Tim has an old monthly statement from Dollar Brokerage stored in his filing cabinet. Tim hires Scanners-R-Us to scan it into one of their computer and upload it onto the System and Scanners-R-US indicates to the System that Tim is the rightful owner of that monthly statement. In this case, Dollar Brokerage is the Originator; Scanners-R-Us is the Source, and Tim is the Owner of that monthly statement.

User Interaction

The user interaction functionality of the System pertains to the tasks a user of the System can perform, other than document-management tasks. User interaction tasks include registering with the System and logging into the System, managing financial institution credentials, viewing documents, managing contacts, customizing the user experience, and deleting various elements.

User Registration

1. User directs his or her browser to the System's website.

2. User enters his/her email address and zip code.

3. A unique invitation is sent (confirms valid email address) to the user.

4. User clicks a link in the email or enters the URL information in the email into a browser. A User Information Entry screen displays that recognizes some identifying information in the URL and associates this web page visit with the previous web page visit and the information that was collected in the previous visit.

5. The user enters his/her name, address, and a phone number.

6. The user creates login credentials to be used for future secure logins.

7. The user selects either a free trial subscription (available for users to try the service for a limited time period) or a permanent, paid subscription.

User Login

1. User directs his or her browser to the System's website.

2. The user is presented with a web page for login.

3. The user enters credentials on the page to be able to access his/her account.

If the user forgets his or her password, the System provides an interface that enables the user to authenticate himself or herself and create a new password:

1. The user enters his or her username.

2. The System presents a list of the financial institutions that the user has set up in the System (see “Source Management” discussed later below).

3. The user selects a financial institution from the list.

4. The user enters an account number for an account he or she has with the selected financial institution.

5. If the account number matches an account number that the System has associated with that financial institution for that user, the System enables the user to specify a new password to use for future secure logins.

Source Management

The System enables users to configure their profile to indicate from which Sources they want to acquire documents.

Supported Versus Unsupported Sources

In alternate embodiments, users can initiate manual document collection or configure the System to collect documents automatically from supported Sources. Supported Sources are institutions for which the System is preconfigured with institution information such as the URL, Source name, and navigation components. For more information, see “Document Acquisition” discussed later below. Unsupported Sources are institutions that the System recognizes, but for which it is not preconfigured. Document collection is unavailable for those Sources; users can only upload documents manually for unsupported Sources. For more information, see “Manual Document Upload” discussed later below. The user can alternatively opt to create a Source labeled “Other”, which is intended for institutions that the System does not recognize or for documents that are not associated with an institution.

Account Creation for Supported Sources

1. In the System's website, the user navigates to myAccounts, and clicks Add Account.

2. The user selects the Source where the account is held from a list of Sources supported by the System.

3. The user clicks Add on the Institutions page.

4. The user enters their login information (credentials) for the Source website.

5. If desired, the user can opt to save the credentials to the System. (In another embodiment, the user can also set the frequency interval for the System to automatically retrieve documents from the Source without user intervention.) If the user chooses to store credentials in the System, the System can automatically, without user intervention, acquire documents on behalf of the user. Otherwise, the user must manually initiate each document acquisition process, providing credentials each time.

6. The System validates the credentials by logging into the Source website using the Source-specific routines described in “Document Acquisition” later below.

7. If the Source requests particular user information and/or prompts with a challenge question, the System passes the information request and/or challenge question to the user. Once the user enters the relevant information and/or answer into the System, then the System relays the relevant information and/or answer into the Source's website.

8. The System creates a login for the Source and shows the user an updated list of Sources for the user's profile.

9. As a background process, ADAM collects the documents and metadata from the Source and adds them to the System.

10. This embodiment works if the documents are available on the Source website. Some Sources require users to switch to paperless documents. This embodiment requires the user to switch to paperless documents. In an alternative embodiment, the System would be able to make the switch to paperless documents on the user's behalf using the techniques described in “Document Acquisition” later below.

11. The System captures the account types and account numbers that a user holds at the Source and creates the appropriate accounts in the System. In an alternative embodiment, the user can enter this information.

Account Creation for Unsupported Sources

1. In the System's website, the user navigates to myAccounts, and clicks Add Account.

2. The user selects an unsupported Source for sources that the System recognizes, but for which it has no preconfigured settings. Alternatively, the user selects Other for unrecognized Sources.

3. The user enters a nickname for the account.

4. The System validates the information entered and creates the account.

Scheduled Versus Manually Initiated Acquisitions

Users can configure the System to automatically collect documents at a scheduled interval without user intervention. Alternatively, users can opt to manually initiate document collection; in that case, the System only acquires documents when users manually intervene to initiate the acquisition.

Scheduled Acquisitions

Users can specify how often they want the System to acquire new documents. For example, document acquisitions can be scheduled to occur weekly, monthly, quarterly, and yearly. For these scheduled acquisitions, users must have stored their credentials for the Source in the System.

Manually Initiated Acquisitions

For manually initiated acquisitions, users can opt to store their credentials for Sources, or they can choose to provide that information at the time of acquisition. When the System starts an interactive acquisition, it checks for stored credentials. If none are stored, the System prompts the user to enter the credentials. Users have the option to then store the credentials if they so wish.

Viewing Documents

To view a particular document, the user does the following:

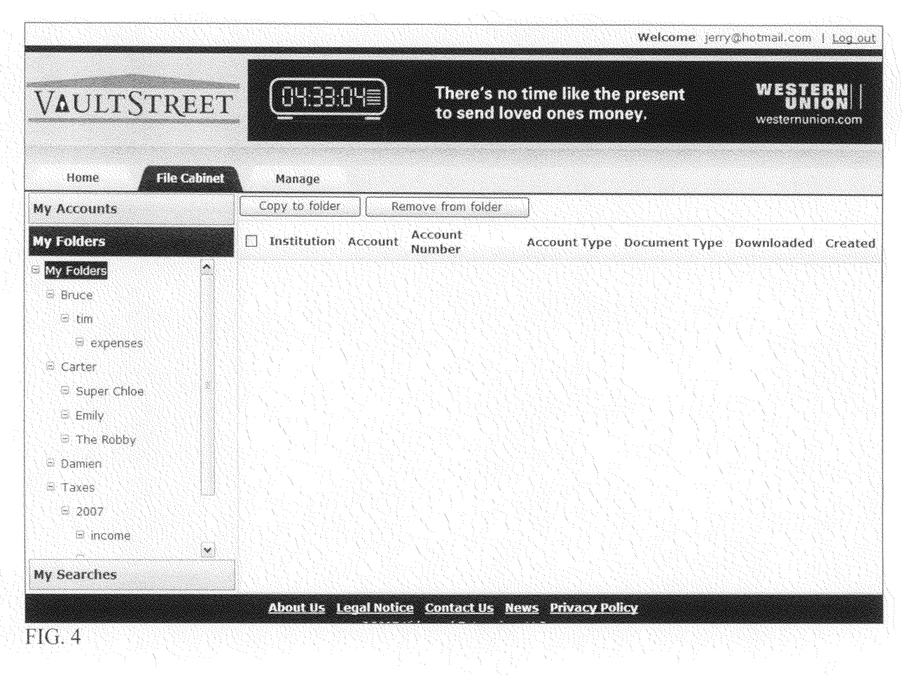

1. The user accesses the File Cabinet. The System provides the user with a list of custom folders (see “Managing Folders” discussed later below), similar to the My Folders tree illustrated in FIG. 4.

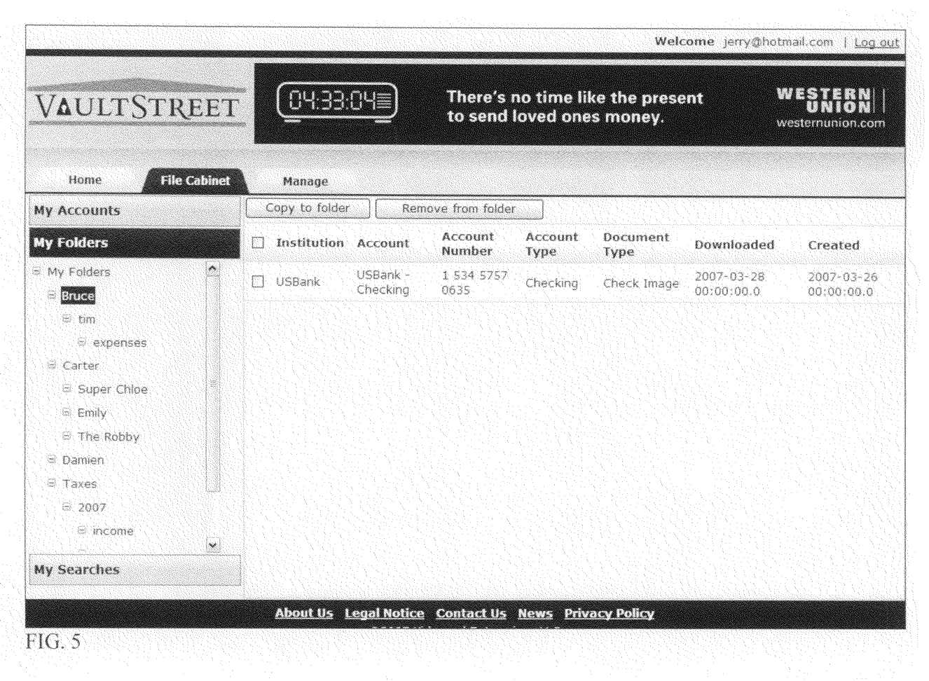

2. The user selects a folder that contains the desired document. The System lists the documents associated with that folder, in a manner similar to the document list for a user's folder illustrated in FIG. 5.

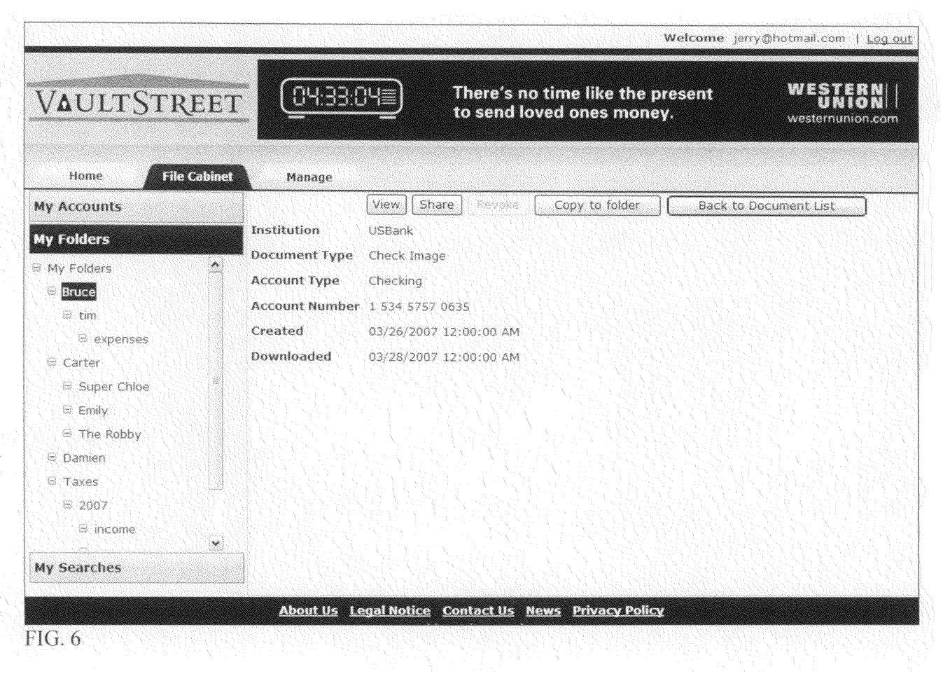

3. From the document list, the user can access information about the desired document by selecting the document in the list, in a manner similar to the document management page illustrated in FIG. 6. From the document information page, the user can choose to view the document. The System decrypts the document (see “Decryption” discussed later below), and displays the selected Digital Document in a separate page.

Contact Management

U.S. patent application Ser. No. 11/750,178 (US 2008/0005024A1) discloses enabling users to confidentially share their documents in a distributed embodiment where the documents are stored on users' local computers. The present System includes software implemented components that enable users to securely share documents with other users. For more information, refer to “Sharing Documents” discussed later below. The sharing process is designed to work with the Contact Management process through which Senders and the Recipients of their documents can gain confidence that they are only sharing Digital Documents with who they intend to. The System thus provides a process by which users can view certain verified information about one another as a means to mutually authenticate one another.

This section describes one or more embodiments for users to mutually authenticate one another, which employ the following common mechanisms:

1. Mutual authentication of the Sender and Recipient

2. Creation of an address book of verified Contacts

3. Address book is integrated with mechanisms for secure centralized storage and sharing of certain Digital Documents.

In the verified Contact information embodiment, the System automatically verifies that a particular person has access to both the email and phone number provided. The Sender's Contact information is verified first. As described in the User Registration process, Sender's email addresses are verified when they first register with the System. When Senders want to share one or more documents with a Recipient, they are asked to confirm which phone number they want to have verified. This can be the number entered during the registration process, or a different number.

The System automatically calls the phone number supplied by the Sender and plays a recorded message that includes a one-time authorization code. The Sender then has to enter that one time key into the appropriate field in the application. In the event that the Sender wants to change either his/her email address or phone number at some future time, they would need to verify those before they could be changed. The Sender's email address is used in the invitation to the Recipient and the Sender's phone number is shown to the Recipient when they register with the System so that the Recipient can determine how confident they are that the Sender is who the Recipient expects him/her to be.

When a Sender invites a Recipient, the Sender enters the Recipient's email address and phone number into the invitation form. The System emails an invitation to the Recipient and informs the Recipient that the Sender wants to securely share one or more documents with the Recipient and that to get access to the document, the Recipient must register with the System. The invitation includes a link with embedded identification information, such as the Sender's phone number.

If the Recipient accepts the invitation, the System calls the phone number that the Sender provided for the Recipient plays a recorded message with an authorization code. The Recipient must enter that one time code into the appropriate field in the System. This confirms that the Recipient had access to the phone number provided by the Sender. Once the Recipient has entered the one time key he or she can get access to the document(s) that the Sender wanted to share with him or her.

Once a Recipient's information has been verified, the Sender and the Recipient become verified Contacts in one another's address books, and the two users can securely share documents any time they want via the secure central document repository. The Contact information only has to be verified once. Either user can remove the other from his or her address book by hiding the Contact.

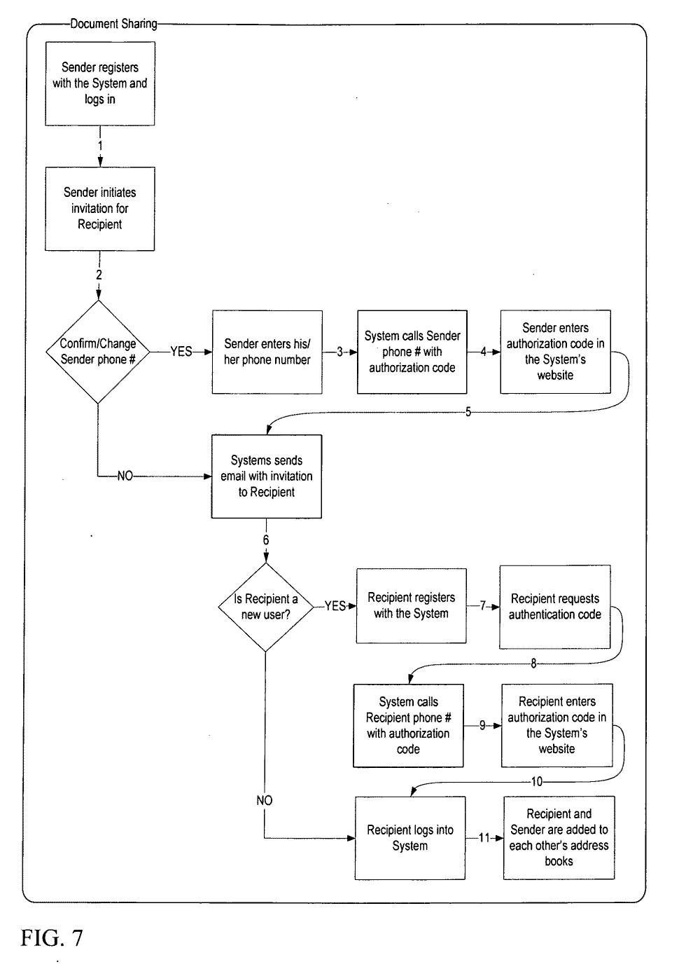

The sequence below illustrates the verified Contact information embodiment of document sharing (see FIG. 7):

1. In the System's Web site, the user selects “Manage My Contacts”, enters the email address, name, and phone number of the new Contact the Sender wants to share one or more documents with.

2. If the Sender has not yet verified her phone number, the System prompts the Sender to verify his/her phone number.

3. The Sender can modify the phone number provided during the registration process. The Sender requests the System to call the provided number and play an authentication code.

4. The Sender enters the authentication code in the System.

5. The System verifies if the entered code matches the code sent to the Sender's phone. If the codes match, the System sends an invitation to the Recipient's email address. If the codes do not match, the System prompts the Sender to try again.

6. The Recipient clicks the link in the email.

7. The System displays a page asking the Recipient to log into the System to accept the invitation.

8. If the Recipient is not yet a registered user, the System has the Recipient go through the registration process.

9. The Recipient logs into the System to view the invitation.

10. The Systems prompts the Recipient to verify his phone number to confirm his/her identity.

11. The Recipient requests the System to send an authentication code to the phone number provided by the Sender.

12. The System calls the Recipient's phone number with an authentication code.

13. The Recipient enters the authentication code in the System.

14. If the code is correct, the System completes the invitation process. If the code does not match, the System prompts the Recipient to try again.

15. The Recipient can now view the Acquired Document by clicking Documents Received From Contacts on the home page of the System's website. For more information about viewing document, see “Viewing Document” discussed above. The Sender and the Recipient added to each other's address book for future sharing of documents.

In the one time key embodiment:

1. In the System's website, the user selects “Manage My Contacts”, enters the email address for the intended recipient and the Sender enters a unique string of text and/or numbers and/or other symbols into the System. The Sender also selects one or more Acquired Files he or she wants to share.

2. The Sender then can tell the recipient the unique string (either face to face, by phone, or by any other means)

3. An invitation is sent (as described in step 5 above) to the e-mail address provided by the Sender.

4. The Recipient clicks the link in the email (which contains some identifying data).

5. The System displays a page asking the Recipient to log into the System to accept the invitation.

6. If the Recipient is not yet a registered user, the System has the Recipient go through the registration process.

7. The Recipient logs into the System to view the invitation and is requested to enter the unique string. If they do not then the System does not present the Acquired File(s) to that user. If they do then the System presents the Acquired File(s) to the Recipient.

In the shared secret embodiment:

1. In the System's website, the user selects “Manage myContacts”, enters the email address for the intended recipient. Then the Sender enters a question into the System that he or she believes would be hard to guess the answer to by someone other than the intended recipient. The Sender also selects one or more Acquired Files he or she wants to share.

2. An invitation is sent (as described in step 5 above) to the e-mail address provided by the Sender.

3. The Recipient clicks the link in the email (which contains some identifying data).

4. The System displays a page asking the Recipient to log into the System to accept the invitation.

5. If the Recipient is not yet a registered user, the System has the Recipient go through the registration process.

6. The Recipient logs into the System to view the invitation and is presented with the question. The Recipient types into the System his or her answer.

7. That answer is presented to the Sender. If the Sender believes the answer is correct then they select the “I accept this Contact” button. If the Sender does not believe the answer is correct then they select the “I do not accept this Contact” button.

8. If the Sender selects the “I do not accept this Contact” button then the System does not present the Acquired File(s) to that user. If the Sender selects the “I accept this Contact” button then the System presents the Acquired File(s) to the Recipient.

Hide/Show

The System enables users to manage the user experience by giving them the option to hide or show various elements, including Accounts, Contacts, and Folders.

Account Hide/Show

The System enables an Owner to set an Account to “Hide” or “Show.” A “hidden” Account still exists in the System, and the System still collects documents related to that Account (see “Document Acquisition” discussed later below). However, a “hidden” Account, and the documents associated with that Account, do not appear in the File Cabinet. This feature enables users to prevent Accounts that have become inactive or are infrequently used from being listed.

Contact Hide/Show

The System enables an Owner to set a Contact to “Hide” or “Show.” A “hidden” Contact still exists in the System, but does not appear in a list of Contacts with whom to share a document. Also, any documents received from or shared with a “hidden” Contact will not appear in a list of shared or received documents.

Folder Hide/Show

The System enables an Owner to set a Folder to “Hide” or “Show.” A “hidden” Folder still exists in the System, and still has its documents associated with it, but it but does not appear in the File Cabinet.

Element Deletion

System Account Deletion (Cancellation)

The System enables a user to cancel his or her System account, after which the user is no longer registered with the System. When a user cancels his or her System account, all of the user's documents, Account information, and financial institution credentials are permanently deleted.

Institution Deletion

The System enables a user to remove a financial institution that he or she had previously set up in the System. When a user's institution is removed, all documents that were acquired from that institution are permanently deleted from the System, and any documents that were shared with third parties are no longer available to those third parties.

Account Deletion

The System enables a user to remove an account that the System had previously set up for him or her. When an account is removed in this manner, all documents that were acquired for that account are permanently deleted from the system, and any documents that were shared with third parties are no longer available to those third parties. Furthermore, the System will no longer collect documents pertaining to that account.

Contact Deletion

The System enables an Owner to remove a Contact from his or her Contacts list. Any documents that the Owner has shared with that Contact will no longer be available to that Contact.

Folder Deletion

The System enables an Owner to remove a custom Folder from his or her File Cabinet (see “Managing Folders” discussed later below). The documents associated with that Folder are not deleted.

Document Acquisition

The System provides three methods for acquiring documents: (a) Manual upload; (b) Push or pull via secure peer-to-peer network connection; and (c) Download via secure HTTP or FTP connection.

Manual Document Upload

A user can upload a Digital Document to the System manually. Before the document is added to the System, the user needs to manually provide the following descriptive metadata: (a) Originator of the document; (b) Creation date of the document; (c) Account number (Blank is an option); (d) Type of Account (Other is an option); and (e) Type of Document (Other is an option).

The follow steps are undertaken:

1. On the File Cabinet—Account page, the user clicks a button to import a document. The System displays the Import Document screen.

2. The System automatically captures and stores the fact that this particular user is the Source for all uploaded documents (the user can not alter the Source information).

3. The user navigates to the document file to be uploaded, enters the document name and type, and selects the account for the document to be uploaded to in the System.

4. The user clicks a button to upload the document.

5. The System verifies that the document satisfies the upload policy and scans the document for viruses. The upload policy consists of restrictions on the file format and maximum file size.

6. The System automatically records the user as being the Source for all uploaded documents.

7. The System updates the user's document list.

If an Owner downloads an acquired document from the System to his or her local computer, alters it, and then manually uploads it back to the System, the altered document will be stored separately from the original, and the altered document's authenticity evidence data will show that the Source is the Owner and not the financial institution, thereby alerting potential third-party users that the document may not be genuine.

Secure Peer-to-Peer Connection

In this method, the System provides application programming interfaces (APIs), which would specify in detail how third-party software can interact with the System. The APIs would also provide secure forms of communication with particular Sources and the Sources would then be able to push new Digital Documents and related contextual data, document authenticity evidence, and/or metadata to the System. For this method, the Source indicates to the System which user of the System is the Owner of particular documents.

For this method, either the Source's computer server or the System would provide a way for a user to indicate that he/she not only wants to receive Digital Documents but that he/she wants them to be sent to the System. If the user indicated his/her consent to the System, then that consent would be transmitted to the Source. In an alternative embodiment, the System initiates communication with the Source's computer in order to “pull” documents and related metadata into the System.

Download Via Secure HTTP or FTP Connection

U.S. patent application Ser. No. 11/750,178 (US 2008/0005024A1) describes an auto download function and an archive function. In the embodiments described in that application, both functions run locally on users' computers. In the present embodiment ADAM is an agent that runs on a centralized server.

ADAM's Navigational Functionality

In this embodiment, the auto download function is referred to as the Automatic Document Acquisition Module (ADAM). The System is also able to receive documents uploaded manually by users (see below for details). ADAM's function is to collect Digital Documents and information about those Digital Documents (document metadata) from document Sources (For example an insurance company's website). ADAM emulates user behavior, such as logging into and navigating around the website, to download documents and collect pertinent, related, data from the Source. Servers typically use a mixture of HTML and JavaScript. When users interact with website pages through a browser, JavaScript may be executed. The System's programmers used the following process to analyze Source websites to program ADAM:

1. An account with online account management was opened at an institution.

2. Programmers logged into the account and analyzed user actions required to access Digital Documents and metadata from the website. This would typically involve navigating to the website, filling in forms and clicking links, and submitting the required data for the forms and links to the server. For details about the analysis process, see “Source Website Analysis” discussed later below.

3. Using the information from the evaluation, programmers developed a series of components to handle a Source's web site to log in and acquire Digital Documents and metadata from that particular Source. ADAM as such contains specific routines for each Source it supports.

ADAM includes a scheduler that automatically determines when to attempt to acquire documents from a particular Source on behalf of a particular Owner. (In an alternative embodiment, the System enables Owners to configure how frequently they want Digital Documents are to be acquired from a particular Source.) Alternatively, a user can initiate the document acquisition process for a given Source on demand.

ADAM is able to log in to protected websites that require the presentation of Credentials. Users enter the relevant Credentials into the System in the Account Creation for Supported Sources process. Those Credentials are encrypted and stored by the System and retrieved as needed to access a particular Source's website. ADAM uses a user's Credentials for a particular Source and passes it to the routine specifically designed for that Source to collect Digital Documents that are available on that Source's website for that user.

In the event that Sources change, for example, if a website is updated, the Source-specific routine for that Source may need to be updated to function appropriately. As such, there is a need for human intervention by programmers and quality assurance personnel to monitor the updates of Sources and to adjust Source-specific routine as Sources change. As Source-specific routines are modified the System is updated to replace the old routines with the new routines.

Source Website Analysis

In the process of developing ADAM, programmers analyzed Source web pages. Programmers created software routines that reproduce web browser behavior inside ADAM. Programmers must analyze certain web page of the Source in order to determine what that web browser behavior should be. The analysis would involve:

1. Form Submission

User interaction with the server can occur as HTML forms. Programmers analyze forms to extract form fields. A form field is a name/value pair. Field values can be entered directly by the user or modified by JavaScript as a result of user interactions with the web page. The programmers created software components to emulate execution of the JavaScript to arrive at the values the server expects.

2. URL Generation

Links send a get request to the server via HTML or Java script. Programmers analyzed the links and created software components so that ADAM sends the appropriate get request to the server for each link.

3. HTML Modification

JavaScript may modify some aspects of the HTML content tree. Those modifications may result in a browser sending a request to a server to retrieve the updated content. The server may track those updates to distinguish human users from automated software components. Therefore the programmers must reproduce this behavior when interacting with Source websites. For example, modifying an SRC attribute of the IMAGE HTML element forces the browser to retrieve an updated image from the server.

4. Cookie Management

Servers use cookies to track various user activities. Often cookies are generated or modified by JavaScript as a result of user interactions with the page. The programmers need to determine that behavior to reproduce the behavior in ADAM.

Descriptive Metadata Acquisition

In addition to acquiring Digital Documents, ADAM collects descriptive metadata for each document. In the present application, the following metadata are collected for each document: Source name, Document date, Acquisition Date, Originator name, Owner name, and hash result. In alternate embodiments, a smaller set of metadata may be collected.

ADAM uses the following Sources to collect the metadata about a document: (a) Extracted contents of Digital Documents; and (b) Source web page scrapings

ADAM uses the following items as information sources for metadata:

1. URL Information

ADAM can determine the certain metadata from data contained within institution's website URLs. For example, if a document is collected from www.greatbank.com, ADAM would list the Source name as Great Bank. As another example, if ADAM clicks a link called “statements,” it could use that information to determine that the document type is a statement.

2. Text on the Website or in the Extracted Document Contents

ADAM can identify certain descriptive metadata by searching for certain phrases that are used in particular contexts. When those phrases or data are found, ADAM associates certain descriptive metadata with the relevant document. For example, it may search for the term “Your Bank of America Standard Checking Statement” on documents collected from the Bank of America website. If that exact term is found, ADAM stores the document type as a “Statement” and the account type as a “Checking” account.

3. Location and Proximity of the Data on a Web Page or a Document Page

ADAM can identify certain descriptive metadata based upon the graphical placements of certain data on a page and/or its proximity to other data. In this case, ADAM uses the graphical placement of data or text to locate descriptive metadata. ADAM is programmed to know that certain data or text is located in a particular place on a document or website page from a particular Source and/or of a particular document type and/or on a particular webpage. For example, ADAM could be programmed to look in the upper right-hand corner of a statement from a particular credit card company for the document date. In addition to the location, ADAM can use proximity of items to keywords to find metadata. For example, if a string of 8 digits is located in proximity to the string “account number” then this Component would identify that string of digits to be the account number.

Other Document Acquisition Embodiments

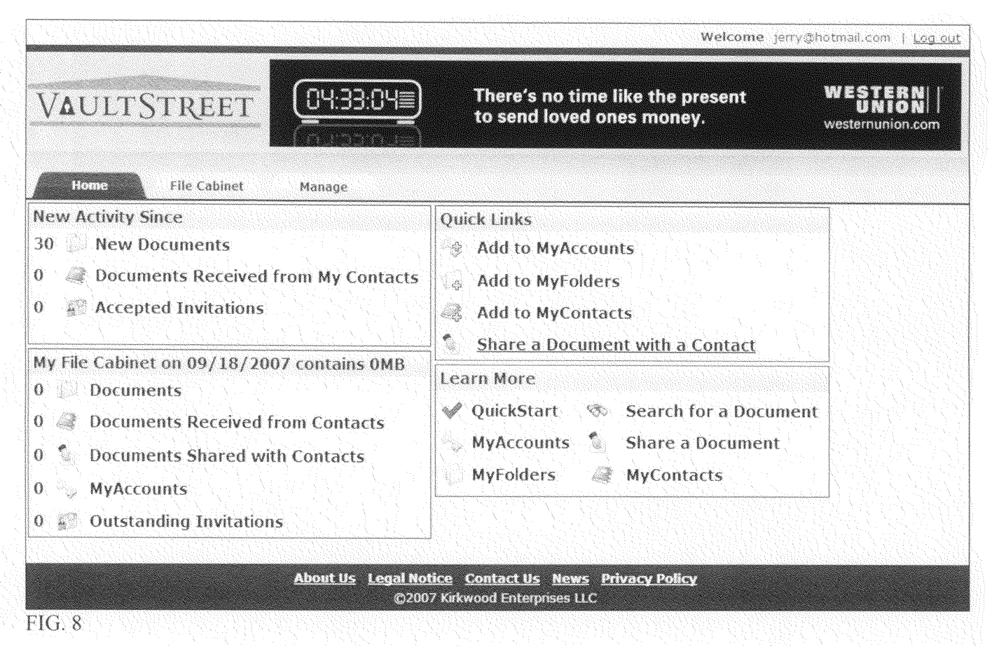

In another embodiment, the Source-specific routines are created, monitored, and updated on a centralized server and the routines are either pushed to an individual user's local computer whenever there is an update or an individual's computer regularly checks with the central server to find out if updated Source-specific routines are available and downloads any updated routines. Managing Documents With MetadataOnce users have registered with the System, and documents have been added to the System through automatic collection or manual upload, users can view, share, and organize their Digital Documents and metadata using the System's Web site. FIG. 8 illustrates the home page for the System's Web site. The user can click the File Cabinet tab from any location in the System's Web site. The File Cabinet is where users can manage documents.

Managing Folders

The File Cabinet displays the accounts into which the documents are automatically organized. The System can use the Originator name, account number, account type, document type, and Document Date to automatically present the documents to each user in an organized fashion that is similar to how many users organize their paper documents in a physical filing cabinet. In particular, the System organizes the documents into folders; one for each account number from each Originator. It then allows users to search or filter documents within those folders by the Document Date or Document Type. Every document in the System is automatically placed into a single folder (documents are not duplicated across multiple folders).

The System enables users to create their own folders (e.g., custom folders) and to organize those folders into a hierarchical structure (e.g., a customized folder structure). Documents can be copied to multiple folders. Documents do not need to be copied to any of the folders. Users can remove documents from a folder without affecting other folders.

Users can manually create and organize folders as follows:

1. The user clicks the Manage tab.

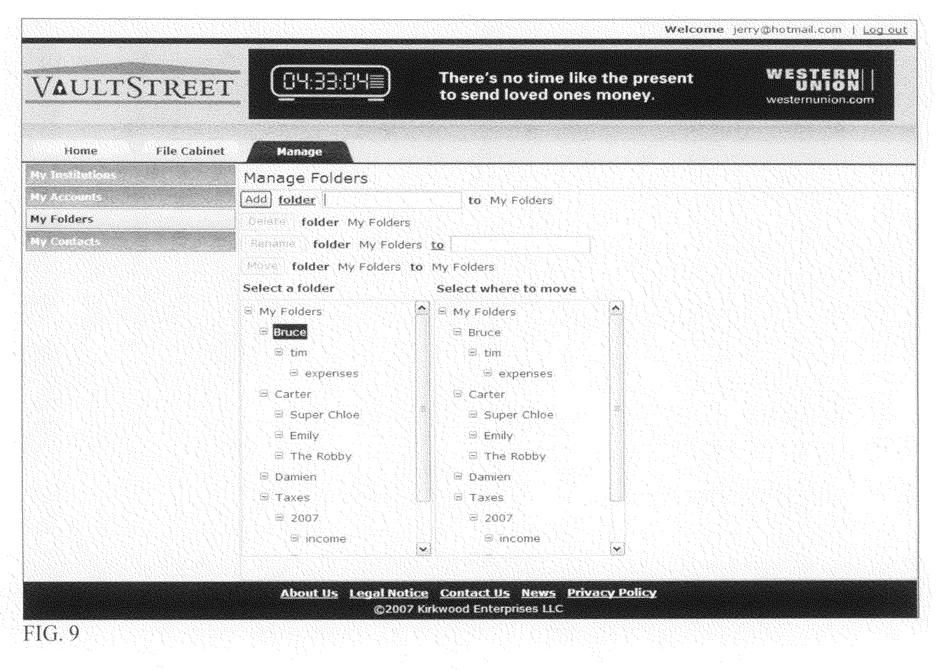

2. The user clicks My Folders. The Manage Folders page appears. FIG. 9 illustrates the Manage Folders page. In the Manage Folder page, users can add, delete, rename, and move folders. Any document can appear in none, one, or multiple folders. Each document must have an Originator, and can have only one Originator. The Originator cannot be changed.

In another embodiment, the System can generate a list of organizational categories (folder names) used by other users, ranked by popularity, as suggestions for organizing the Owner's documents. The System will perform this function as follows:

1. The System will provide an interface that enables the Owner to share the names of the folders the Owner has created in his or her File Cabinet.

2. The System will also maintain a table containing all Owners' shared folder names and a count of how many times each unique folder name is used.

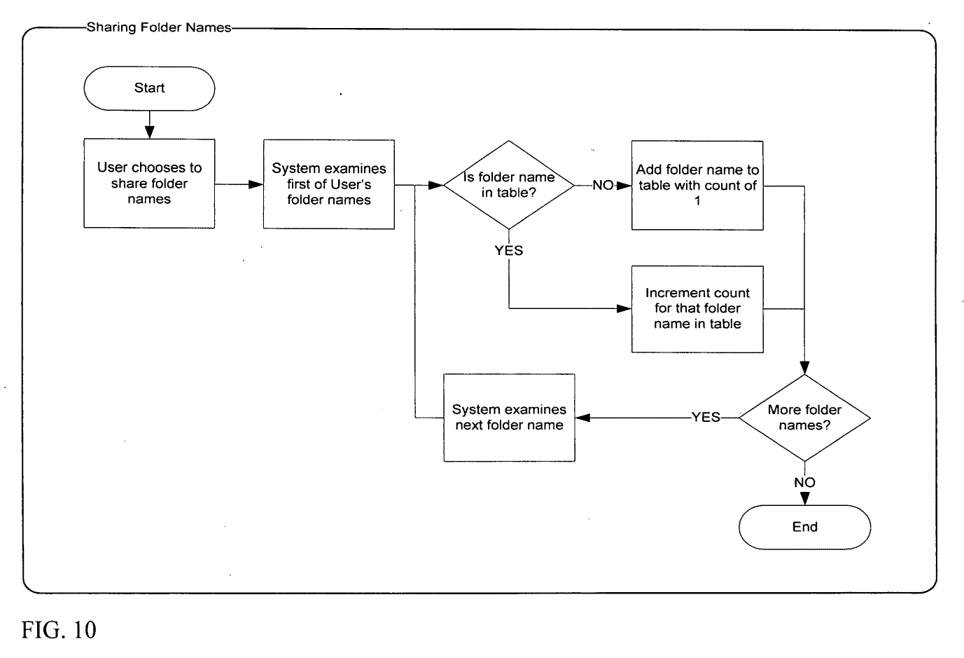

3. Any time an Owner chooses to share folder names, the System looks up each of the Owner's folder names in the table, incrementing the count for existing folder names and adding entries for folder names not already in the table. (See FIG. 10.)

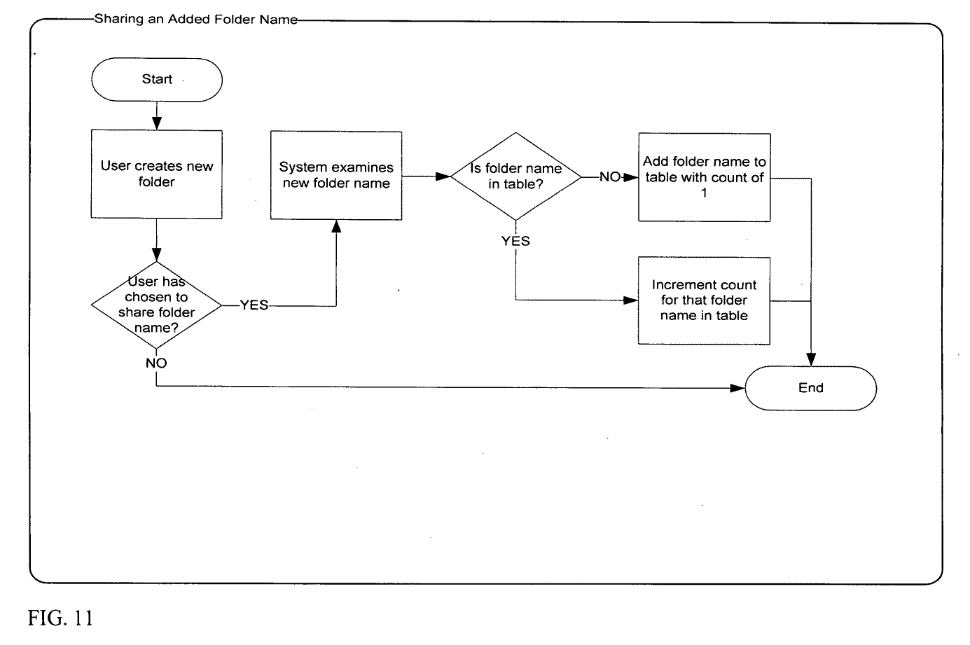

4. Any time an Owner who has chosen to share folder names creates a new folder, the System looks up that folder name in the table. If the new folder name is not in the table, the System adds it to the table with a count of 1. If the new folder name is in the table, the count for that folder name is incremented. (See FIG. 11.)

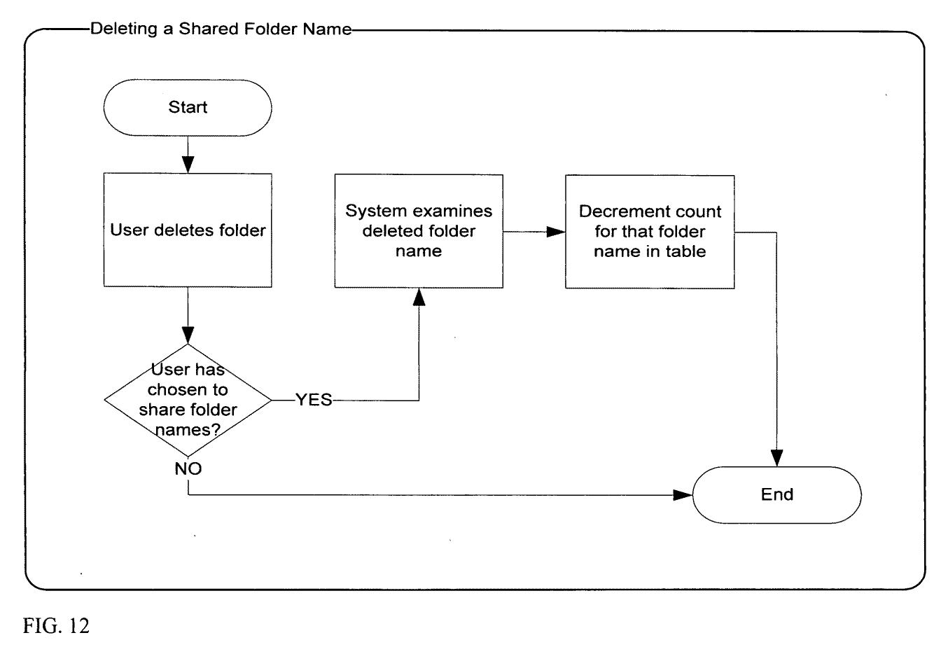

5. Any time an Owner who has chosen to share folder names deletes a folder, the System decrements the count for that folder name. (See FIG. 12)

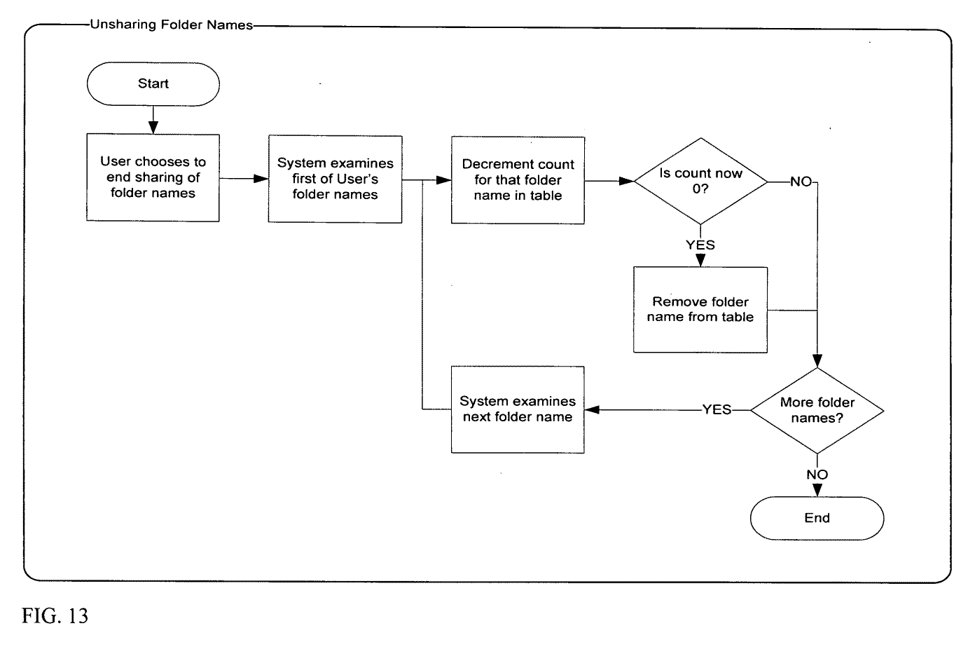

6. Any time an Owner who has chosen to share folder names decides to no longer share folder names, the System decrements the count for each of that Owner's folder names, deleting, entries that have a count of 0. (See FIG. 13)

7. The System will provide an interface that enables the Owner to view a list of folder names, displayed in order of popularity (i.e., decreasing order of how many times each folder name is used). The interface will enable the user, when adding a new folder, to click on a folder name in the list and have a folder with that name added to the desired location in the File Cabinet folder structure.

In another embodiment, the System can enable users to share entire folder structures as suggestions for other users. The System will perform this function as follows:

1. The System will provide an interface that enables an Owner to select a folder in the File Cabinet and share that folder and all of its subfolders (i.e., the folder structure).

2. The interface will also enable the Owner to provide a description or other commentary about the folder structure.

3. The System will store the folder structure and the Owner's description in a database.

4. The System will provide an interface that enables other users to view shared folder structures, to make comments about them, and to rate them (for example without limitation, assigning a “star rating” of 0 to 5 stars). The System will store comments and ratings associated with each shared folder structure, and can display the shared folder structures in order of average rating.

5. The System interface will enable a user to add a shared folder structure to any location in his or her File Cabinet.

System Folders

At acquisition time, the System can automatically assign documents into system folders. A system folder is a preconfigured folder that the System provides and which cannot be deleted. For example, the folder hierarchy could have a Taxes system folder that contains tax year folders, such 2006, 2007, and 2008. The System could then assign all tax-related documents received between Sep. 30, 2006 and Sep. 30, 2007 to the 2007 Taxes folder. The System could use the Digital Document's metadata to determine whether a document is tax-related, for example, if the document is of a particular document type, such as 1099s, W2s, K1s, 1098s. A user would also be able to choose to add or remove documents from the system folders independently of the System's automatically assigning documents to a system folder. For example, the user may believe that a particular document, such as a check or credit card receipt, is relevant for his/her 2007 taxes, and could copy that document into the 2007 Taxes folder. If the System automatically added a particular document to a particular system folder and the user later removed that document from the folder, the System would not re-add that document back into that folder at a later date.

Searching for Documents

1. On the home page, the user clicks File Cabinet.

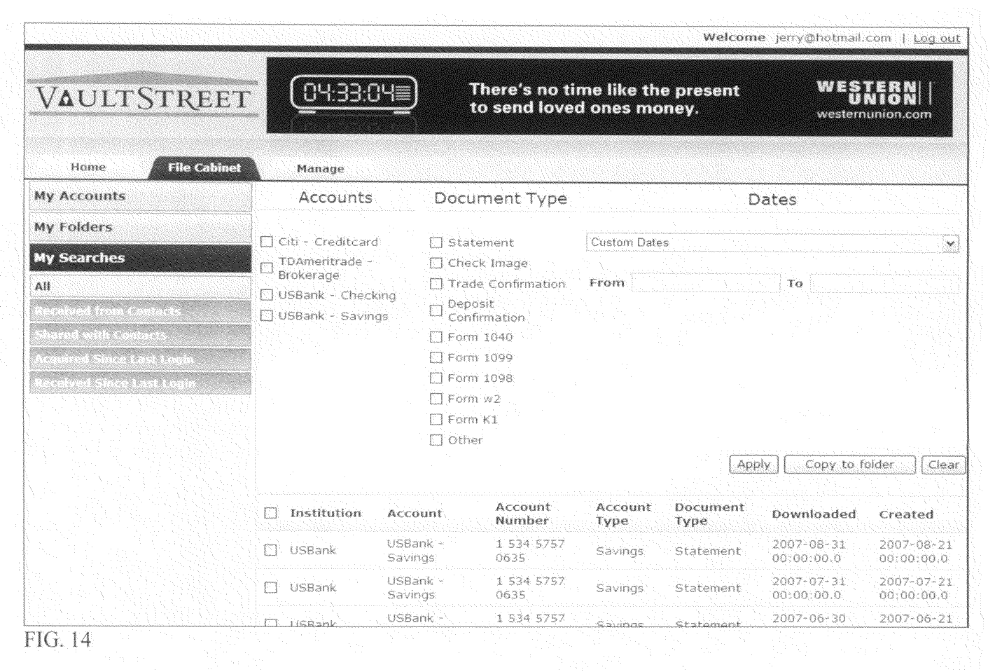

2. The user clicks My Searches. The page shown in FIG. 14 appears, which illustrates how users search for documents.

3. The user enters the search criteria, such as the account, document type, and/or a custom date, and clicks Apply. The documents that meet the search criteria display.

Version Control

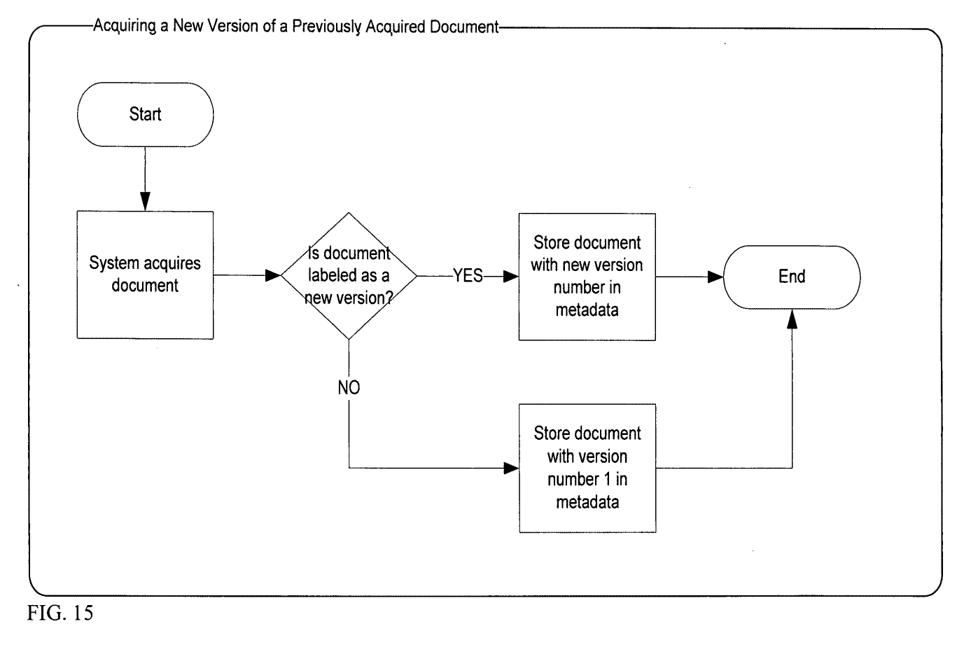

In another embodiment, the System will identify a new version of a given acquired document (for example, when a brokerage generates a new version of a 1099 form for a given tax year), and will indicate the most recent version to the Owner. The System will perform this function as follows (see FIG. 15):

1. As part of the source Web site analysis conducted on each financial institution's Web site (see “Source Website Analysis” discussed above, programmers will determine how each financial institution's Web site signals the availability of a new version of a previously-generated document.

2. In this embodiment, an additional piece of descriptive metadata will be stored for each document to indicate the document's version number.

3. When the System acquires (see “Document Acquisition” discussed above) a new version of a previously-acquired document, the System stores the document separately from the previously-acquired version or versions, and stores the version number in the document's descriptive metadata.

4. When the Owner views any list of documents that includes a document with multiple acquired versions, the System uses the version number metadata to clearly label each version, enabling the owner to view or share the most recent version.

Automatic Check Lists

Year-to-Year Embodiment

The System will enable the Owner to compare a list of particular documents received in one time period to a list of corresponding documents received in another time period, for purposes of compiling a list of documents that have not been received in the latter time period.

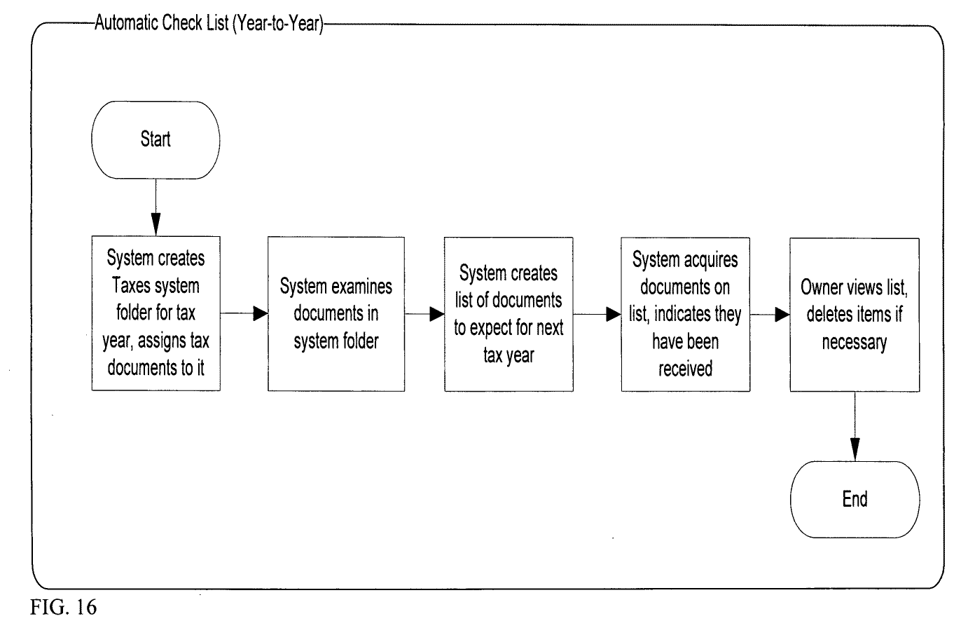

The System will perform this function as follows (see FIG. 16):

1. As discussed in “System Folders” above, the System creates a Taxes folder for each tax year, and automatically populates it with tax-related documents, such as 1099s and K-1s. An owner can assign additional documents to this folder, such as canceled checks for charitable donations or for quarterly estimated taxes.

2. At a suitable time during or after the next tax year, the System will use the documents, descriptive metadata, and contextual data in the previous year's Taxes folder to generate a list of documents that the Owner should expect to receive. The System will enable the Owner to view this list at any time.

3. As the System acquires documents that are on the list, the System updates the list to indicate that these items have been received.

4. The System will enable the Owner to delete items from the list; for example, if the Owner closed an account that previously generated a form 1099, the Owner could delete that item from the list because no form 1099 will be forthcoming for that account.

By way of example only, in step 2 above, if the System had acquired a form 1099 from a bank for one tax year, the System will create a list including a form 1099 from that bank for the next tax year, and indicate whether or not it has been received. If the System does receive the document, in step 3 above the System would update the list to indicate it had been received. In that way, the Owner can track the status of his or her tax documents and follow up with financial institutions that have not generated needed tax documents.

Received Statements Embodiment

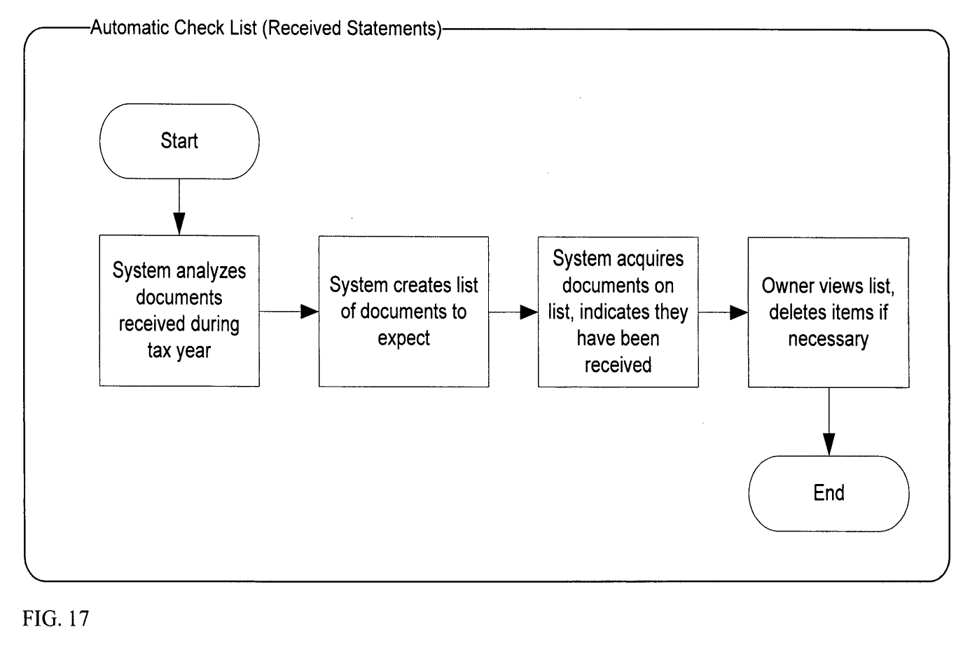

The System would use the fact that documents (such as statements), indicating activity in an account, had been received regarding an account during a tax year in order to indicate to the Owner that the appropriate tax document or documents should be expected, and whether or not they have been received. The System will perform this function as follows (see FIG. 17):

1. At a suitable time after the end of a tax year, the System analyzes the documents received during the tax year, searching for activity in accounts (such as savings, money-market, and brokerage accounts) that should result in a tax document being generated.

2. The System uses the results of this analysis to compile a list of tax documents that the Owner should expect to receive. The System will enable the Owner to view this list at any time.

3. As the System acquires documents that are on the list, the System updates the list to indicate that these items have been received.

4. The System will enable the Owner to delete items from the list; for example, if the Owner knows that a certain account did not earn enough interest to generate a form 1099, the Owner could delete that item from the list because no form 1099 will be forthcoming for that account.

Automatic Document Sharing

The following automatic document sharing embodiments are possible:

Automatic Forwarding

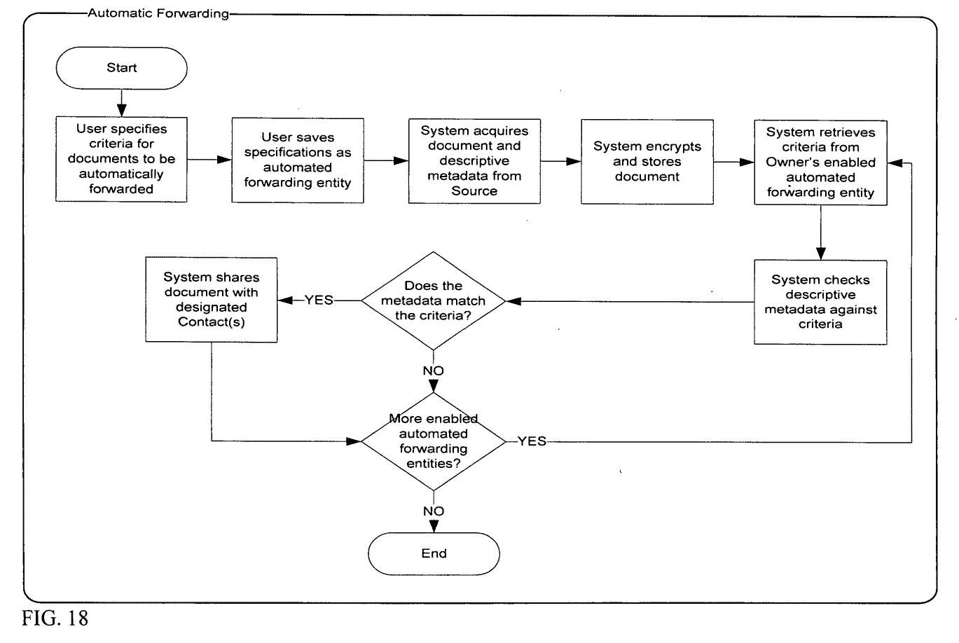

An Owner can instruct the System to automatically share, upon acquisition, all documents meeting certain criteria with one or more third parties. The System will perform this function as follows (see FIG. 18):

1. The System will provide an interface, similar to the Searching interface (see “Searching for Documents” discussed above), that enables an Owner to specify certain metadata values for documents that he or she wants to have automatically shared with one or more Contacts.

2. The System will also provide an interface that enables an Owner to select the one or more Contacts with which to share documents that meet the criteria specified in step 1 above.

3. The System will enable the Owner to save the specifications made in steps 1 and 2 with a specific name, as an “automated forwarding entity.” The Owner will be able to save multiple automated forwarding entities, each with different specifications and different names. The Owner will be able to enable or disable individual automated forwarding entities.

4. Each time the System acquires a document for an Owner (see “Document Acquisition” discussed above), the System examines the descriptive metadata (see “Descriptive Metadata Acquisition” discussed above) associated with that document and determines if it meets the criteria for any of the enabled automated forwarding entries for that Owner.

5. If the document meets the criteria for any of the enabled automated forwarding entries for that Owner, the System automatically shares that document with the designated Contact or Contacts.

By way of example only, all form 1099 documents can be automatically shared with a third-party tax preparer. In steps 1 through 3 above, the Owner would select documents of type “1099,” and would select the Contact who is the Owner's tax preparer. The Owner would save these selections as a named automated forwarding entity, ensuring that the automated forwarding entity is enabled (i.e., the System will execute it). Each time the System acquires a document, the System will compare the document's descriptive metadata against the selections in the saved automated forwarding entity. When a document of type “1099” is encountered, the document is automatically shared with the selected tax preparer.

In an alternative embodiment, as part of the saved automated forwarding entity, the Owner can select a time frequency with which to share identified documents (i.e., so that documents meeting the criteria are shared all at once at the end of each time period, rather than shared individually as they are acquired). This embodiment incorporates all the features described in the base Automatic Forwarding embodiment, with the following enhancements:

1. In step 1 in the base embodiment, the interface will include a time-frequency selection that enables the Owner to choose how often (for example without limitation, weekly or monthly), to forward documents to the selected Contact or Contacts.

2. In step 4 of the base embodiment, instead of examining each document as it is acquired, at the end of each time period the System will examine all documents that were acquired during the period, and compare each document against all enabled automated forwarding entities.

3. In step 5 of the base embodiment, the System will forward all documents that meet the criteria of any of the enabled automated forwarding entities.

In an alternative embodiment, as part of the saved automated forwarding entity, the Owner can specify a minimum number of documents meeting the criteria that the System should acquire before sharing them. This embodiment incorporates all the features described in the base Automatic Forwarding embodiment, with the following enhancements:

1. In step 1 of the base embodiment, the interface will include a minimum-document selection that enables the Owner to specify how many matching documents must be acquired before sharing them.

2. In step 5 of the base embodiment, the System will maintain a list of documents that meet the criteria for each enabled automated forwarding entity, and share them automatically with the designated Contact or Contacts when the minimum number of documents is reached.

Automatic Forwarding With Approval

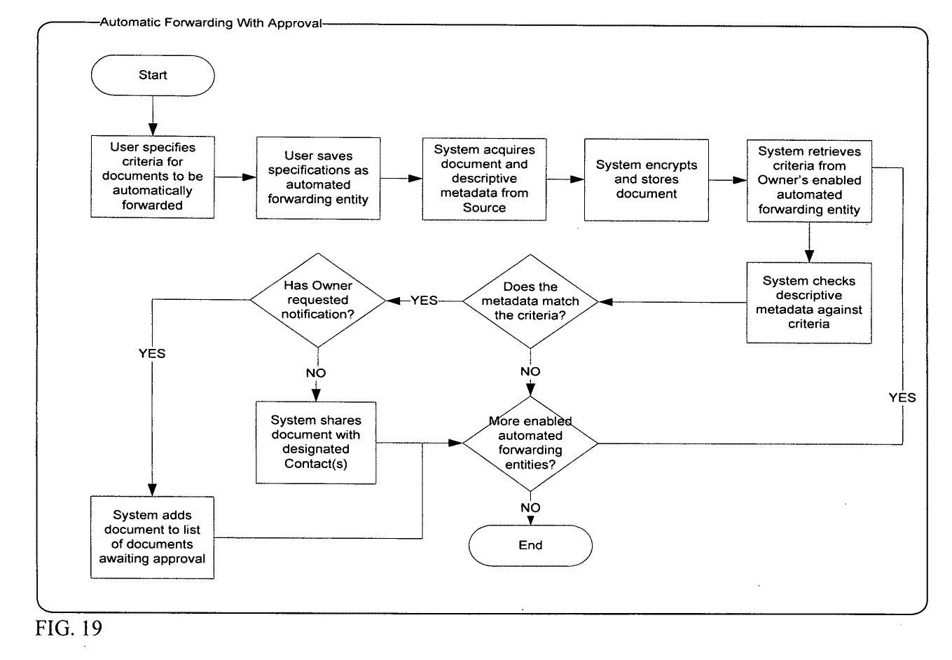

This embodiment is similar to the Automatic Forwarding embodiment, except that prior to sharing the document or documents, the System would notify the Owner that one or more documents are ready to be shared, and give the Owner the opportunity to approve or deny sharing for any particular document or for all documents. The System would perform this function as follows (see FIG. 19):

1. The System will provide an interface, similar to the Searching interface (see “Searching for Documents” discussed above), that enables an Owner to specify certain metadata values for documents that he or she wants to have automatically shared with one or more Contacts.

2. The System will also provide an interface that enables an Owner to select the one or more Contacts with which to share documents that meet the criteria specified in step 1 above.

3. The System's interface will also enable the Owner to indicate, for a given set of criteria, whether the System should notify the Owner for approval prior to sharing documents.

4. The System will enable the Owner to save the specifications made in steps 1 through 3 with a specific name, as an “automated forwarding entity.” The Owner will be able to save multiple automated forwarding entities, each with different specifications and different names. The Owner will be able to enable or disable individual automated forwarding entities.

5. Each time the System acquires a document for an Owner (see “Document Acquisition” discussed above), the System examines the descriptive metadata associated with that document and determines if it meets the criteria for any of the enabled automated forwarding entries for that Owner.

6. If the document meets the criteria for any of the enabled automated forwarding entries for that Owner, and if the Owner has requested notification prior to sharing, the System adds the document to a list of documents awaiting approval. If the Owner has not requested notification, the System automatically shares that document with the designated Contact or Contacts as in the Automatic Forwarding embodiment.

7. At a specified time interval (for example without limitation, daily or weekly), the System will send the Owner an email notification that there are documents awaiting approval. In an alternative embodiment, the System notifies the Owner that there are documents awaiting approval the next time the Owner logs into the System.

8. The System will enable the Owner to view a list of documents that are awaiting approval and the Contact or Contacts to whom they are to be shared. The Owner can choose, with a single click, to approve or deny all documents to all Contacts, or can choose to approve or deny individual documents and individual Contacts.

Third-Party Request

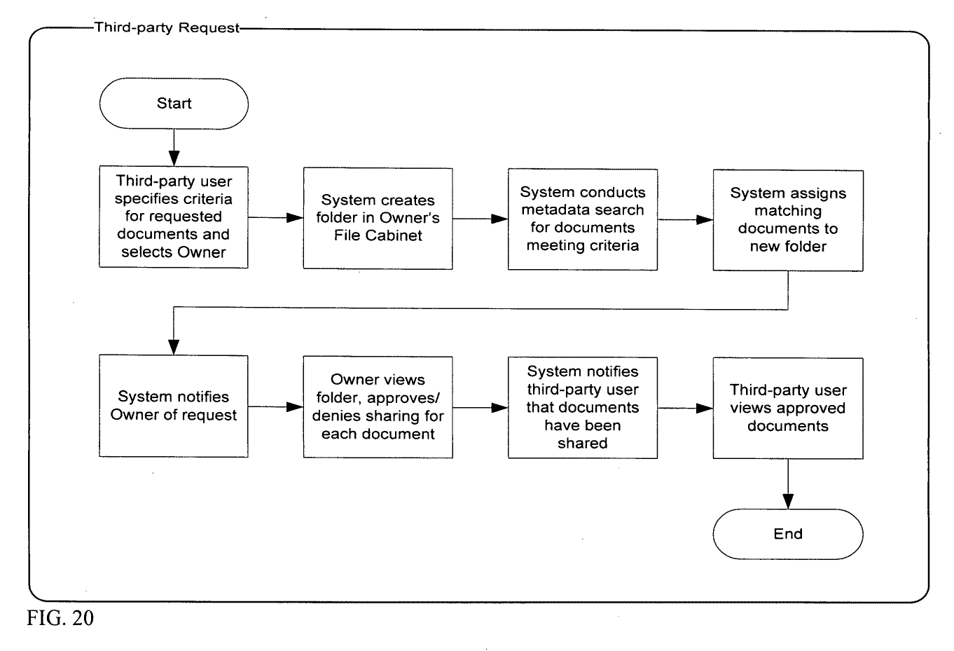

In this embodiment, a third-party user can request that all of an Owner's documents meeting certain criteria be shared. The System would perform this function as follows (refer to FIG. 20):

1. The System will provide an interface, similar to the Searching interface (see “Searching for Documents” discussed above), that enables a third-party user to specify certain metadata values for the Owner's documents that the third-party user wants to have access to.

2. The System's interface will also enable the third-party user to select the Owner from the third-party user's list of Contacts (see “Contact Management” discussed above).

3. Upon receiving the request, the System creates a unique folder in the Owner's File Cabinet, and using the metadata criteria specified in step 1, submits a query to the database, requesting a list of matching documents.

4. The database returns a list of matching documents. The System assigns these documents to the folder created in step 3.

5. The System then notifies the Owner by email that a Contact has requested documents. In an alternative embodiment, the System notifies the Owner the next time the Owner logs into the System.

6. The System enables the Owner to view the contents of the folder created in step 3, and to approve or deny sharing for each document (or for all documents, with a single click). The Owner then saves these approval/denial specifications.

7. The System then notifies the third-party user that the requested documents have been shared.

For example without limitation, in this embodiment a mortgage broker could use the interface in steps 1 and 2 to request all W-2 statements for the last three years for an Owner who is applying for a loan. In steps 3 and 4, the System would create a unique folder in the Owners File Cabinet, and assign those W-2 statements to that folder. In step 5, the System would notify the Owner that the mortgage broker has requested the documents, and in step 6, the Owner would view the list of documents and choose whether or not to share each one. After the Owner makes these selections, in step 7 the System would notify the mortgage broker that the documents have been shared.

Third-Party Request of System Folder

As discussed in “

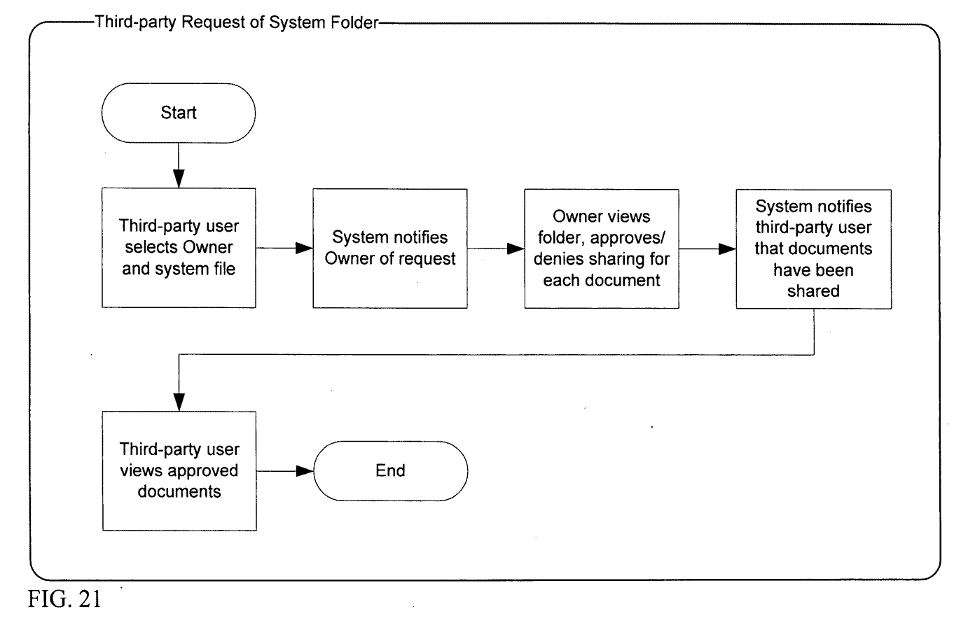

System Folders” above, the System can create folders and automatically assign documents to them, for example without limitation, folders for tax-related documents for each tax year. In this embodiment, a third-party user, such as a tax preparer, could request all the documents in a system folder (for example, a “2007 Taxes” folder) for a particular Owner. The System will perform this function as follows (see FIG. 21):

1. The System will provide an interface that enables a third-party user to select an Owner for the third-party user's list of Contacts (see “Contact Management” discussed above).

2. The System's interface will also enable the third-party user to select the desired system folder or system folders from a list of system folders in the Owner's File Cabinet.

3. The System then notifies the Owner by email that a Contact has requested documents. In an alternative embodiment, the System notifies the Owner the next time the Owner logs into the System.

4. The System enables the Owner to view the contents of the requested system folder or system folders, and to approve or deny sharing for each document (or for all documents, with a single click). The Owner then saves these approval/denial specifications.

5. The System then notifies third-party user that the requested documents have been shared.

Third-Party Search and Request

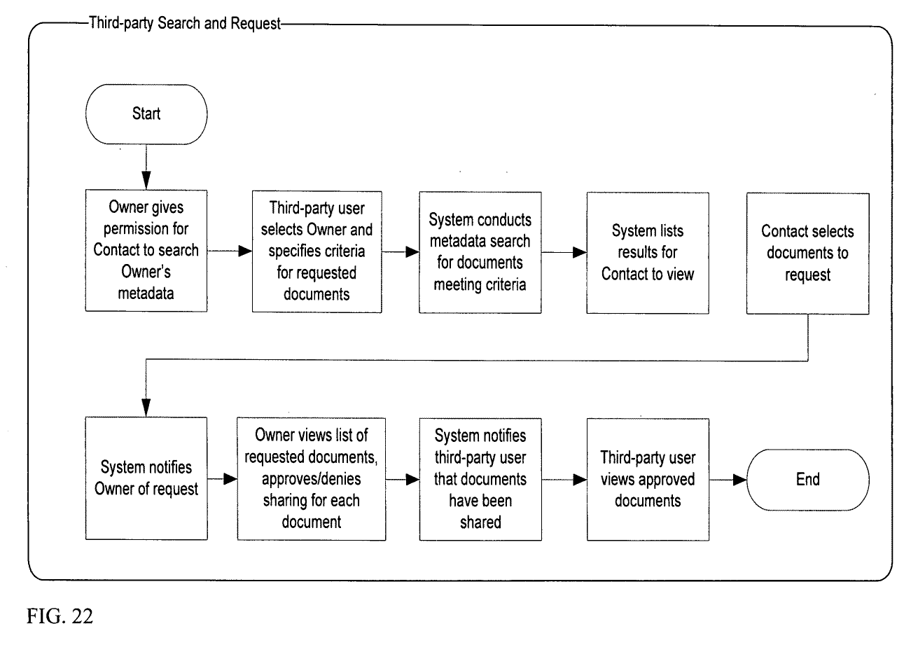

In this embodiment, an Owner can give permission to one or more third-party users to conduct a search of the metadata for the Owner's documents (see “Searching for Documents” discussed above). Using the results of the search, the third-party user can select documents that he or she would like to view. The System would then notify the Owner (by email, or when the Owner logs into the System, or by some other means) that the third-party user is requesting access to those documents. The Owner would have the opportunity to approve or deny sharing for any particular document or for all documents. The System will perform this function as follows (see FIG. 22):

1. The System will provide an interface that enables a third-party user to select the Owner from a list of Contacts (see “Contact Management” discussed above) who have given the third-party user permission to conduct a metadata search of their documents.

2. The System will also provide an interface, similar to the Searching interface (see “Searching for Documents” discussed above), that enables a third-party user to specify certain metadata values for the Owner's documents that the third-party user wants to have access to.

3. Using the metadata criteria specified in step 2, System submits a query to the database, requesting a list of matching documents.

4. The database returns a list of matching documents. The System's interface will display these results to the third-party user. The System's interface will enable the third-party user to select those documents he or she wants to have access to, and to request access to those documents.

5. The System then notifies the Owner by email that a Contact has requested documents. In an alternative embodiment, the System notifies the Owner the next time the Owner logs into the System.

6. The System enables the Owner to view the list of requested documents, and to approve or deny sharing for each document (or for all documents, with a single click). The Owner then saves these approval/denial specifications.

7. The System then notifies third-party user that the requested documents have been shared.

Contextual Data

Contextual Data Format Library

U.S. application Ser. No. 11/750,178 (US 2008/0005024A1) describes some forms and uses for contextual data. Contextual data can be in any format, but typically in a format that is based on Extensible Markup Language (XML). Common examples of XML-based contextual data formats include the Open Financial Exchange (OFX) format and the U.S. Internal Revenue Service's standard XML format. Other institution- or industry-standard formats may be used as well.

Contextual Data Creation

The method of creating contextual data depends on the method of document acquisition (see “Document Acquisition” discussed above):

1. For the manual upload method of document acquisition, the contextual data must be uploaded as well, either embedded with the document or in a separate file that the System associates with the document image file.

2. For the secure peer-to-peer connection method of document acquisition, the contextual data is provided by the Source, either embedded with the document image file or in a separate file that the System associates with the document image file.

3. For the secure HTTP or FTP connection method of document acquisition, the contextual data can be embedded in the document image file, or the System can derive or infer it from the document image file. For image files where the content component is stored as text within the file, the System can search the text for keywords. For image files that contain graphical (bitmap) information only, the System can use optical character recognition and analyze the image for keywords and graphical proximity of labels and values.

The contextual data is stored either embedded in the document image file or in a separate file. In an alternative embodiment, the contextual data is combined with the document image data, document metadata, and authenticity evidence information in a single file of a proprietary file format that can be written and read only by the System.

Association of Preexisting Contextual Data With Digital Documents

In the secure peer-to-peer connection method of document acquisition, contextual data for several documents may be provided in a single file. For example, a single contextual data file might contain the data from six or 12 months of monthly statements. In this case, the System can analyze the contextual data to determine which contextual data items should be associated with each document image file.

Contextual Data Extraction

When contextual data is needed for some purpose, the System extracts the required contextual data as follows:

1. In response to a request from a user, or as part of a regularly scheduled process, the System determines what contextual data is needed. Typically the request will be in the form of a combination of document metadata values (in order to narrow the scope of the search to certain documents) and a certain tag or combination of tags (in order to locate the correct contextual data).

2. The System searches the document metadata for the correct document or documents and then searches the associated contextual data for the requested tags.

3. Upon locating the data, the System copies the data, and provides that data to the requester (another part of the System or another software program) in an appropriate format.

In an alternative embodiment, the request (step 1) can come from another software program that communicates directly with the System. In this case, the data is returned to the other software program (step 3) in an appropriate format. The following is one specific example of how the Document Management process and Contextual Data extraction could work together to find and provide the relevant data to an external application:

1. An Owner shares digital documents (collected from multiple Sources) with his or her tax preparer.

2. The Tax preparation software used by that tax preparer is integrated with the System.

3. The tax preparer clicks on a button that causes the Tax Preparation software to initiate the data extraction process.

4. The tax preparation application knows that it needs to find out if any stocks have been sold in the relevant tax year.

5. The tax preparation application sends a request to the System for brokerage “Trade Confirmations” from the relevant tax year (for example, 2007) that also are “Sales” and for the “Stock Symbol” and “Transaction Amount” for each of those “Trade Confirmations.”

6. the System uses document metadata to search all of the Owner's documents that the tax preparer has access to, to select only those documents that are “Trade Confirmations” from the relevant tax year (for example, 2007).

7. The System searches the “Trade Confirmation” documents to select only those Trade Confirmations from the particular tax year (using the Creation Date and Type of Document metadata).

8. The System extracts “Type of Trade” contextual data from each selected document by searching the document for the “Type of Trade” tag.

9. The System selects only those documents whose “Type of Trade” content indicates the transaction was a “Sale” (in this example, assume that only one Trade Confirmation was selected).

10. The System extracts “Stock Symbol” contextual data from each selected document by searching the document for the “Stock Symbol” tag and copying the content data (for example, the symbol could be “IBM”).

11. The System extracts “Transaction Amount” contextual data from each selected document by searching the document for the “Transaction Amount” tag and copying the content data (for example the amount could be “$1,000”).

12. The System provides the content data for the “Stock Symbol” and the “Transaction Amount” to the tax preparation application.

13. The tax preparation application knows that it also needs the cost basis in order to calculate the capital gains.

14. The Tax preparation application then sends a request to the System for brokerage “Trade Confirmations” for “Purchases” of “IBM” shares.

15. The System uses document metadata to search all of the Owners documents that the Tax Preparer has access to, to select only those documents that are “Trade Confirmations.”

16. The System extracts “Type of Trade” contextual data from each selected document by searching the document for the “Type of Trade” tag.

17. The System selects only those documents whose “Type of Trade” content indicates the transaction was a “Purchase” (in this example assume that only one Trade Confirmation was selected).

18. The System extracts “Stock Symbol” contextual data from each selected document by searching the document for the “Stock Symbol” tag.

19. The System selects only those documents whose “Stock Symbol” content data indicates the transaction was for “IBM”” (in this example assume that only one such Trade Confirmation was selected).

20. The System extracts “Transaction Amount” contextual data from each selected document by searching the document for the “Transaction Amount” tag and copying the content data (for example the amount could be “$400”).

21. The System provides the content data for the “Transaction Amount” for the “Purchase” of “IBM” shares to the tax preparation application.

22. The tax preparation application subtracts the “Purchase” “Transaction Amount” from the “Sale” Transaction Amount” to calculate the capital gains ($1,000-$400=$600) and store that in the appropriate place and format in the tax preparation application (which will eventually be used in the printing or transmission of the tax return).

The above example assumes that only two IBM trade confirmations exist in the system for that particular user and that they are both for the same number of shares. If that were not the case, the system would engage other functions to handle lot or average cost accounting rules and could also engage other functions to determine if it was a short or long term gain.

Capital Gains Planning

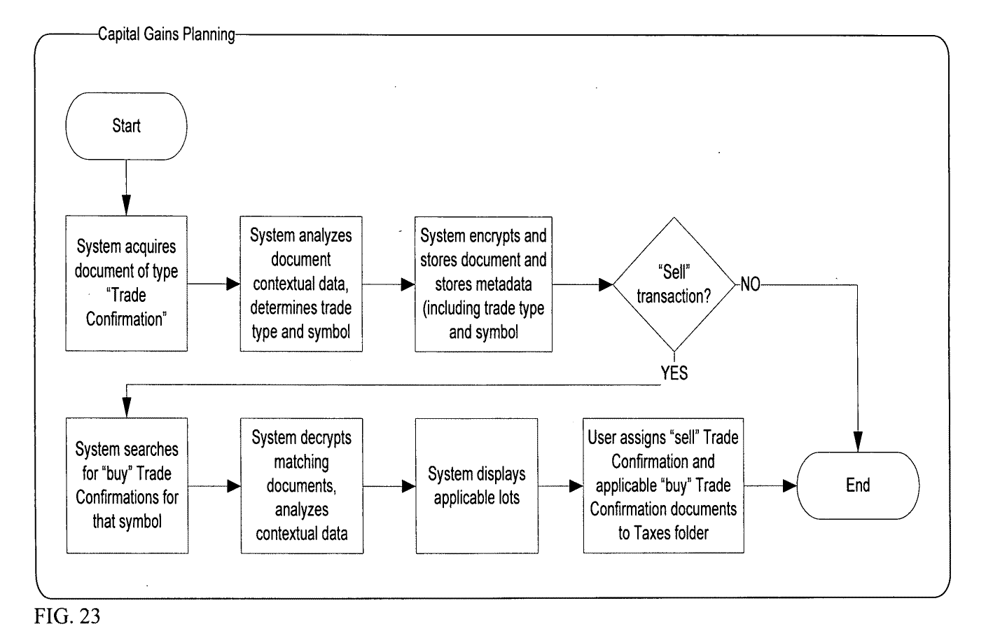

In this embodiment, the System automatically identifies specific lots of purchased shares of stock that could be designated as “sold” following a share sale transaction. This feature will enable users to plan their capital gains for tax purposes. The System will perform this function as follows (see FIG. 23):

1. When the System acquires a Trade Confirmation document from a brokerage, the System will analyze the contextual data to determine what type of transaction it is (such as “buy,” “sell,” “sell short,” and so on), and the symbol for the security (such as stock, bond, option, and so on) that was transacted.

2. For each Trade Confirmation document, the System will store an additional piece of descriptive metadata (see “Metadata” discussed above) containing the transaction type and symbol.

3. The System encrypts (see “Encryption” discussed later below) and stores the document (see “Document Acquisition” discussed above).

4. If the transaction is a “sell” transaction, the System will conduct a metadata search of all previous Trade Confirmation documents in that account to identify “buy” transactions for that stock.

5. They System will then decrypt all matching documents in order to analyze their contextual data.

6. Using the proceeds and number of units data from the “sell” transaction, and the cost and number of units data from the “buy” transactions, the System will list the lots.

7. The System will enable the user to reorder the list in order of ascending or descending capital gains, and will be able to separate the list into long-term and short-term capital gains lists, based on the transaction dates and the current Internal Revenue Service definitions of “long-term” and “short-term.”

8. In another embodiment, the System will enable the user to add a note to the metadata for a given “buy” Transaction Confirmation document, indicating the number of shares that were sold and the date. This feature will prevent the user's inadvertently designating the same lot of shares for more than one “sell” transaction.

9. The System will enable the user to assign the “sell” Transaction Confirmation document and the applicable “buy” Transaction Confirmation document or documents in the Taxes system folder for the appropriate tax year (see “System Folders” discussed above).

In an alternative embodiment, in step 3 above, the System will also search in the contextual data for Statement documents in that account in order to determine if there have been name changes, stock symbol changes, stock splits, or other activity that would affect capital gains calculations, and properly account for these activities when ordering the list of lots (in steps 4 and 5 above).

Integration with Other Software Packages

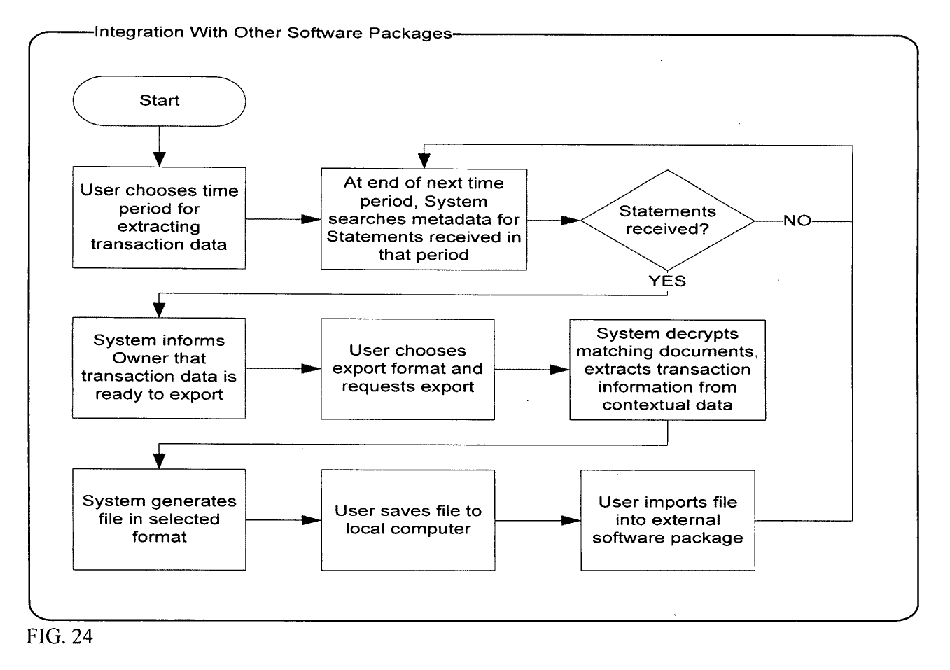

In this embodiment, the System uses contextual data from Statement documents in order to export transaction data for use in other software packages, for example without limitation, Quicken and TurboTax (developed by Intuit, Inc.), TaxCut (developed by H&R Block), Microsoft Excel, and Microsoft Money. The System will perform this function as follows (see FIG. 24):

1. At a frequency chosen by the user (for example without limitation, daily, weekly, or monthly) the System will search document metadata to determine if any documents of type Statement have been received during the time period.

2. If Statement documents have been received, the System will inform the Owner (by email, or the next time the user logs in to the System, or by some other means) that the transaction data is ready to be exported.

3. The System will provide an interface that enables the Owner to choose a format, appropriate to his or her external software package, for exporting the data.

4. The Owner then requests the export.

5. The System then decrypts (see “Decryption” discussed later below) all Statements acquired during the time period and extracts all transaction information from the contextual data.

6. The System generates a file containing the exported data in the format chosen in step 3.

7. The Owner saves the file on his or her local computer, and then uses the target software package to import the data.

Contextual Data Request

This embodiment is an enhancement to the Third-party Request and Third-party Search and Request automatic document sharing embodiments discussed above. In this embodiment, a third-party user can request specific contextual information, along with the documents containing that information, for use in an external software package In this way, the information can be exported in a format that can be read by the mortgage broker's software, eliminating the need to manually re-enter the data.

The System will perform this function as follows:

1. In step 1 of the Third-Party Request or Third-party Search and Request automatic document sharing embodiments, the System's interface will additionally enable the third-party user to request data (in addition to the documents themselves) in one or more of several categories, including without limitation assets, debts, and income, in aggregate form (totaled across all applicable financial institutions), individual form (one entry for each institution), or both.

2. In steps 6 and 7 of the Third-party Request or Third-party Search and Request automatic document sharing embodiments, the Owner additionally approves sharing of the contextual data, and the System notifies the third-party user that the documents are ready to be shared.

3. When the third-party user views the contents of the shared folder, the System gives the third-party user the option to download the requested additional data.

4. Upon request from the third-party user, the System generates a file containing the exported data in a format of the third-party user's choosing, appropriate for the third-party user's software package.

5. The third-party user saves the file on his or her local computer, and then uses the target software package to import the data.

By way of example only, a mortgage broker who is a third-party user of the System can request information such as total assets, total debts, or total income—information that would be aggregated from several documents each—and import that data into a software package that the mortgage broker uses to evaluate the creditworthiness of an applicant (Owner).

Automatic To-Do List

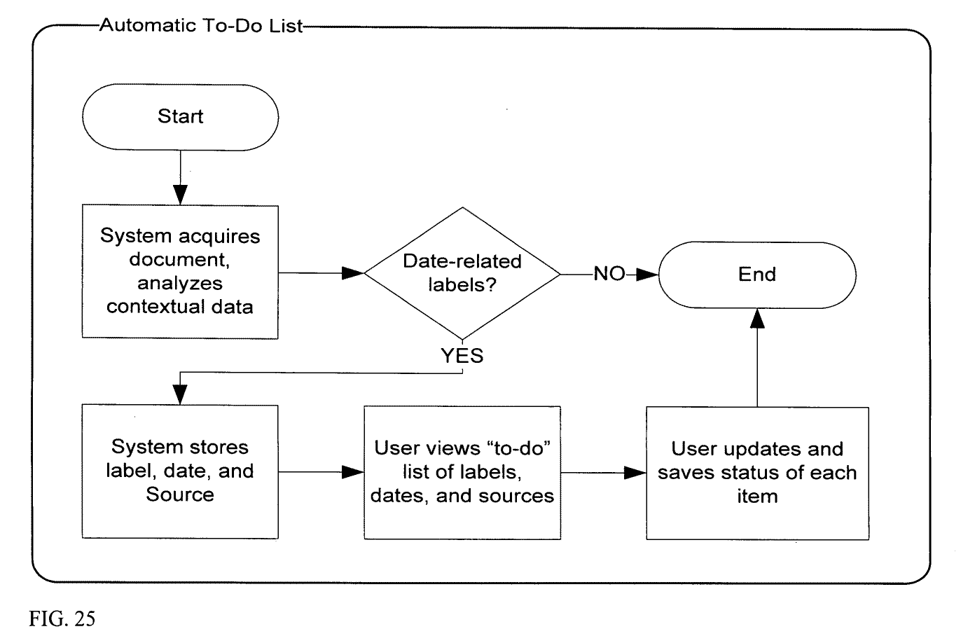

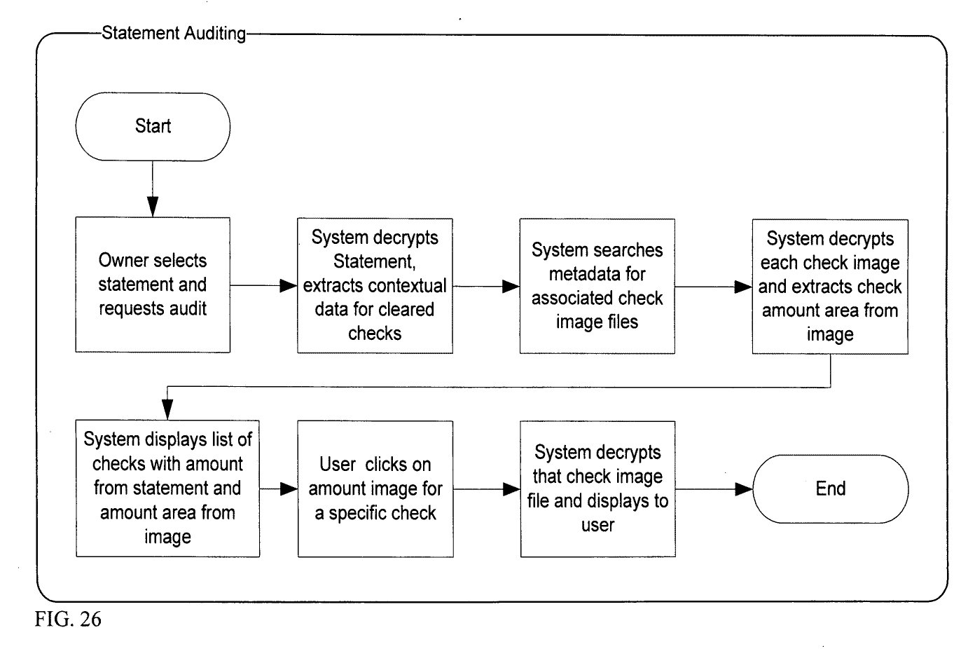

In this embodiment, the System will use contextual data from an Owner's acquired documents to compile a list of important dates and present it to the Owner. The System will perform this function as follows (see FIG. 25):

1. When the System acquires a document, it analyzes the contextual data for that document, searching for date-related labels such as “Due Date,” “Payment Date,” “Mail By Date,” and “Refill By,” and any amounts associated with those dates (for example, the minimum payment due on a credit card bill).

2. When the System encounters applicable labels, it stores the corresponding dates and amounts (if applicable).

3. When the Owner logs in to the System, the System presents a list of upcoming dates and the activities that are to be completed by those dates, in the form of a “To Do” list.

4. The System will enable the Owner to mark each item as “Completed,” “Dismissed,” or other status values. The Owner can instruct the System to display only current items, or only items with a particular status, or items in a specified date range, or some combination.

In an alternative embodiment, the System could notify the Owner of upcoming items by email, text message, or other means.

Statement Auditing

In this embodiment, the System will use contextual data from a checking account statement (or a statement from some other account on which checks can be drawn) and from canceled checks associated with that statement to ensure that the statement and the checks agree. This feature will enable an Owner to identify any discrepancies between the amount a given check was written for and the amount that was debited from the account. The System will perform this function as follows (see FIG. 26):

1. The Owner instructs the System to conduct an audit of a particular statement from a particular account.

2. The System decrypts the document (see “Decryption” discussed later below) and analyzes the document's contextual data, extracting all information related to checks (such as check number, date cleared, and amount).

3. The System then searches the document metadata for the canceled checks identified in step 2, decrypts the check images, and extracts, from each canceled check image file, the area where the check writer writes the numerical amount of the check.

4. The System displays the information from the statement along with the information extracted from each canceled check, so that the Owner can visually compare the amounts and note any discrepancies.

5. The System will enable the Owner to display any listed canceled check image in its entirety.

In another embodiment, in step 3 above, the System could use handwriting recognition technology to “read” the amount on the canceled check and compare it with the amount on the statement, and alert the Owner of any discrepancies. This could be conducted automatically as a background process. In another embodiment, the System could conduct other auditing tasks, such as comparing the date cleared from the statement with the date the check was written, to identify cases where postdated checks were cleared prematurely.

Closed-Circuit Dynamic Content

In these embodiments, the System enables acquired documents to include dynamic advertising content, or any dynamic content (i.e., content that changes each time a user views the document) provided by the Source, in such a way as to preserve the document authenticity evidence data of the static document content. For all methods, the System analyzes the document's contextual data to determine if the document includes any dynamic content.

Superimposed Dynamic Content

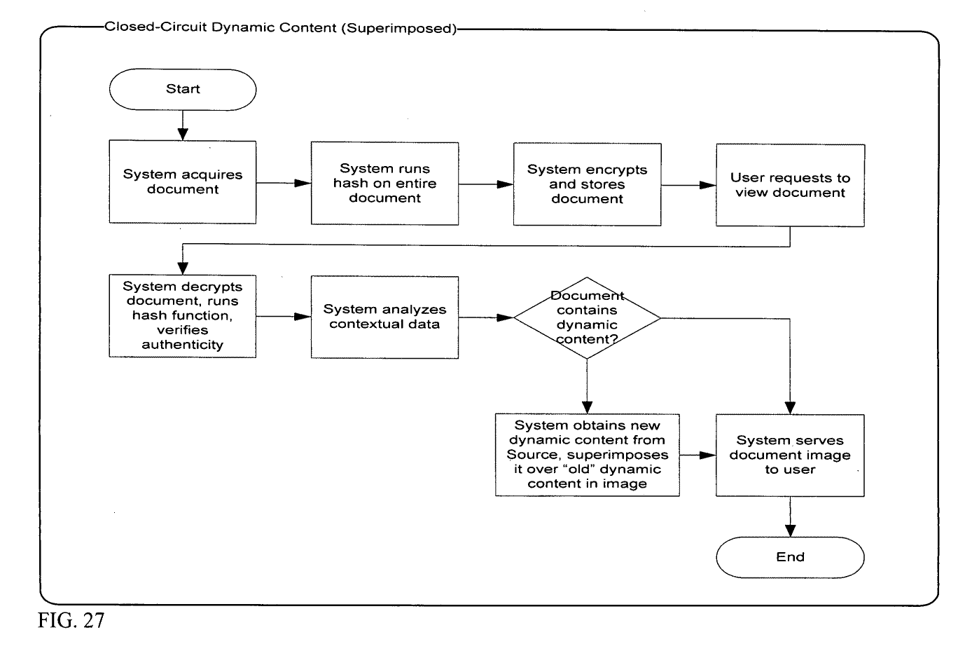

In this embodiment, new dynamic content is superimposed over the original dynamic content, as follows (see FIG. 27):

1. When a document is acquired (see “Document Acquisition” discussed above), the System runs the hash function (see “Document Authenticity Evidence Process” discussed later below) on the entire document (including any dynamic content), then encrypts and stores the document (see “Encryption” discussed later below).

2. On a subsequent request to view the document, the document is decrypted (see “Decryption” discussed later below), and the System analyzes the document's contextual data to determine if it contains dynamic content. The system also runs the hash function on the decrypted document (including the “old” dynamic content, if any), and the two hash functions are compared to verify the authenticity of the document.

3. If the System determines that the document contains dynamic content, when the document is served up to the user, new dynamic content is obtained from the Source and superimposed over the original dynamic content.

Replaced Dynamic Content, With Hash On Static Content Only

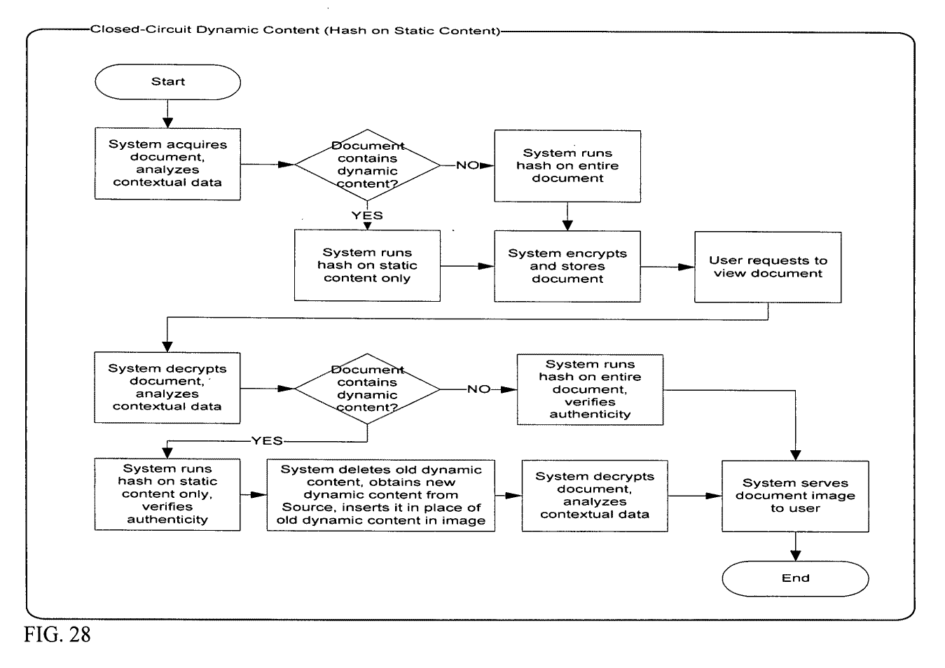

In this embodiment, the System replaces the old dynamic content with new dynamic content, as follows (see FIG. 28):

1. When a document is acquired (see “Document Acquisition” discussed above), the System analyzes the document's contextual data to determine if the document includes any dynamic content.

2. If the document does include dynamic content, before it is encrypted and stored, a hash function is run on only the static portion of the document. (The dynamic portion is excluded from the hash function.)

3. On a subsequent request to view the document, the document is decrypted, the hash function is run on the static portion of the document, and the two hash functions are compared to verify the authenticity of the document.

4. When the document is served up to the user, the original dynamic content is deleted, and new dynamic content is obtained from the Source and inserted into the rendered document.

Replaced Dynamic Content, with Hash on Entire Document

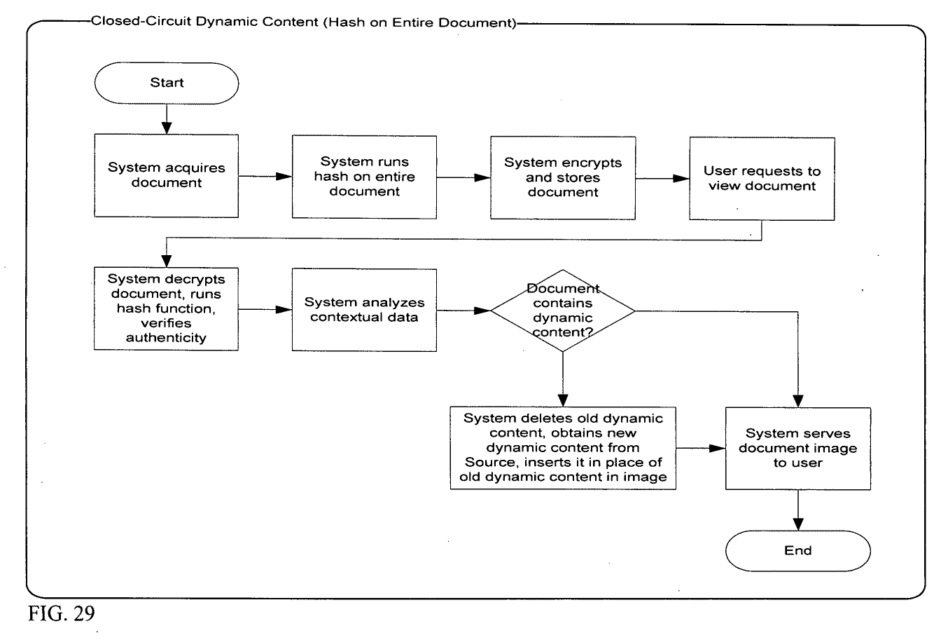

In this embodiment, the System replaces the old dynamic content with new dynamic content as follows (see FIG. 29):

1. When a document is acquired (see “Document Acquisition” discussed above), the System runs the hash function (see “Document Authenticity Evidence Process” discussed later below) on the entire document (including any dynamic content), then encrypts and stores the document (see “Encryption” discussed later below).

2. On a subsequent request to view the document, the document is decrypted (see “Decryption” discussed later below), and the System analyzes the document's contextual data to determine if it contains dynamic content. The system also runs the hash function on the decrypted document (including the “old” dynamic content, if any), and the two hash functions are compared to verify the authenticity of the document.

3. If the System determines that the document contains dynamic content, when the document is served up to the user, the old dynamic content is deleted, and new dynamic content is obtained from the Source and inserted into the rendered document.

Sharing Documents

Basic Document Sharing

To share a document with another user, the user does the following:

1. From any page in the System where the user can see a list of documents, the user can select one or more documents they want to provide access to. Once the documents have been selected, the user can click the Share button. Alternatively, from any particular document management page, the user can click the Share button. In the current embodiment, users can only share documents for which they are the Owner.

2. The System presents a list of Contacts that have been established through the “Contact Management” process (see “Contact Management” discussed above).

3. If the user wants to share one or more documents with an individual or entity that is not yet in his or her address book (as distinct from another user's address book), the System initiates the “Contact Management” process (see discussion above) to add that individual or entity to the particular user's address book before any documents are made available to that individual or entity.

4. After a user has selected one or more Contacts to share documents with, the System makes that shared documents available to the selected Contact(s). The System also tracks all sharing activities, recording what documents have been shared with which Contacts.

5. When a Contact wants to view a shared document, the System uses the Owner's key to decrypt that particular document before it is presented to the Contact.

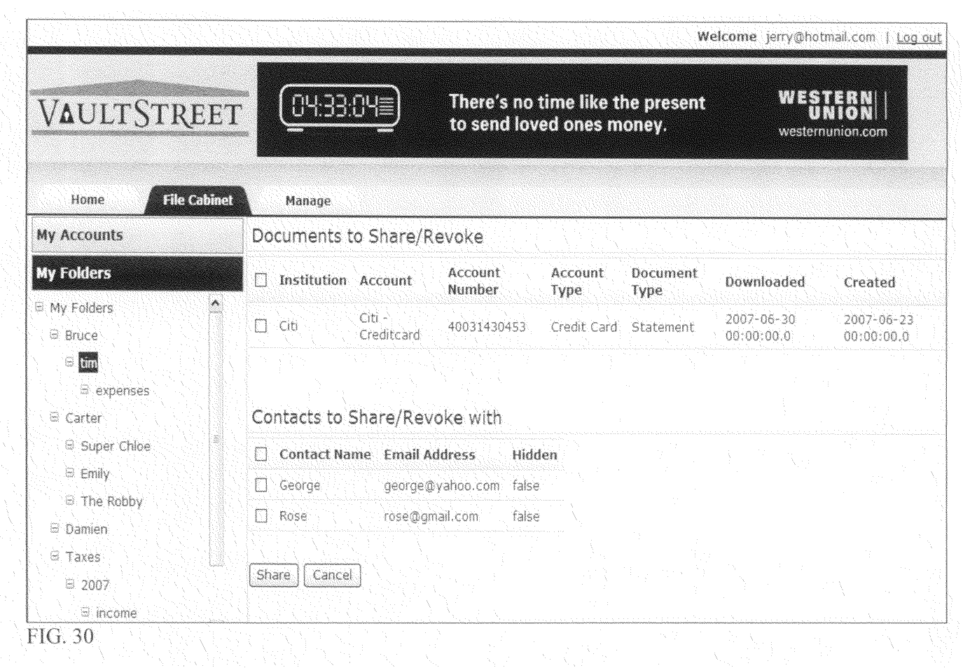

FIG. 30 illustrates the Documents to Share/Revoke pane.

Redaction

In other embodiments, the System would enable the Owner to hide or cover (redact) certain information on a document prior to sharing it, so that a third-party user could not see or electronically discover that information. The extractable (field-specific) contextual data described in U.S. application Ser. No. 11/750,178 (US 2008/0005024A1), paragraph 00044, can relate each piece of information in a document to an area of the document's image file.

Manual Redaction With Contextual Data

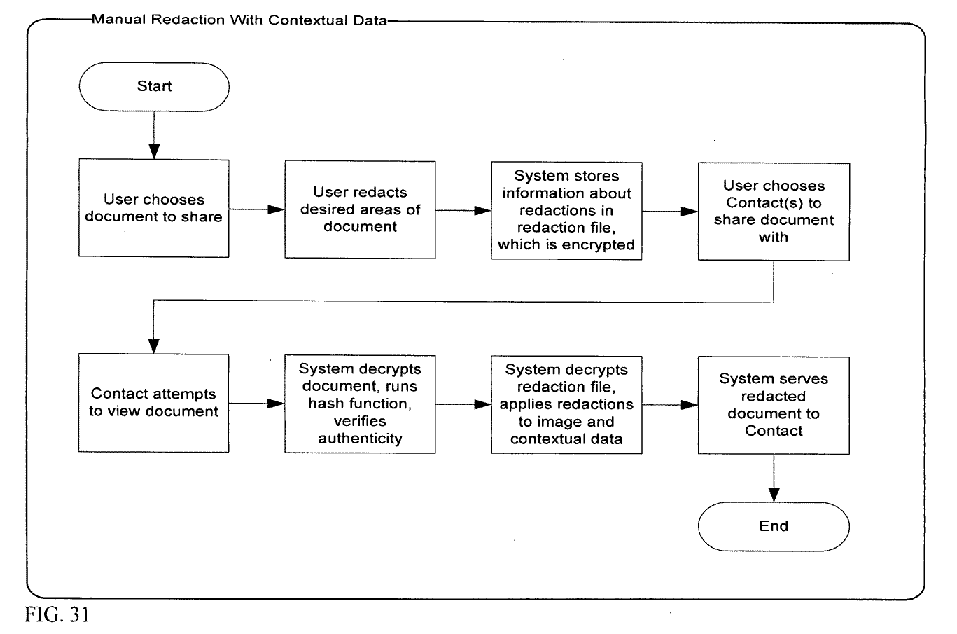

In this embodiment, the Owner redacts portions of a particular document for a particular sharing instance, where the document has extractable contextual data associated with it. The System performs this function as follows (see FIG. 31):

1. As part of the document sharing interface (see “Basic Document Sharing” discussed above), the System enables an Owner to view, for purposes of redaction, the image of a document to be shared.

2. The System's interface enables the Owner to select, on the document's image, the portions of the document to redact (by clicking on the affected data values, or by drawing redaction boxes over the desired areas, or by some other means).

3. When the Owner is finished making redaction selections, the Owner saves the redacted image. The System encrypts and stores information about the redacted areas and redacted contextual data in a file (called the “redaction file”) stored separately from, but associated with, the image file.

4. As in the basic document sharing embodiment, the Owner then proceeds to share the document with one or more Contacts. The System notifies that Contact or Contacts that there are new shared documents available.

5. When a Contact chooses to view the shared document, the System first decrypts the document (see “Decryption” discussed later below), then runs the hash function on the decrypted document to verify that it has not been altered since it was acquired. The System also decrypts the associated redaction file.

6. The System uses the information in the redaction file to apply redactions to appropriate areas of the image, and to delete the extractable contextual data associated with those areas.

7. The system then serves up the redacted copy of the document to the Contact. (In another embodiment, the System would run a second hash function on the redacted image of the document, so as to indicate to the Contact which parts of the redacted document were altered by the redaction process.)

Automatic Redaction

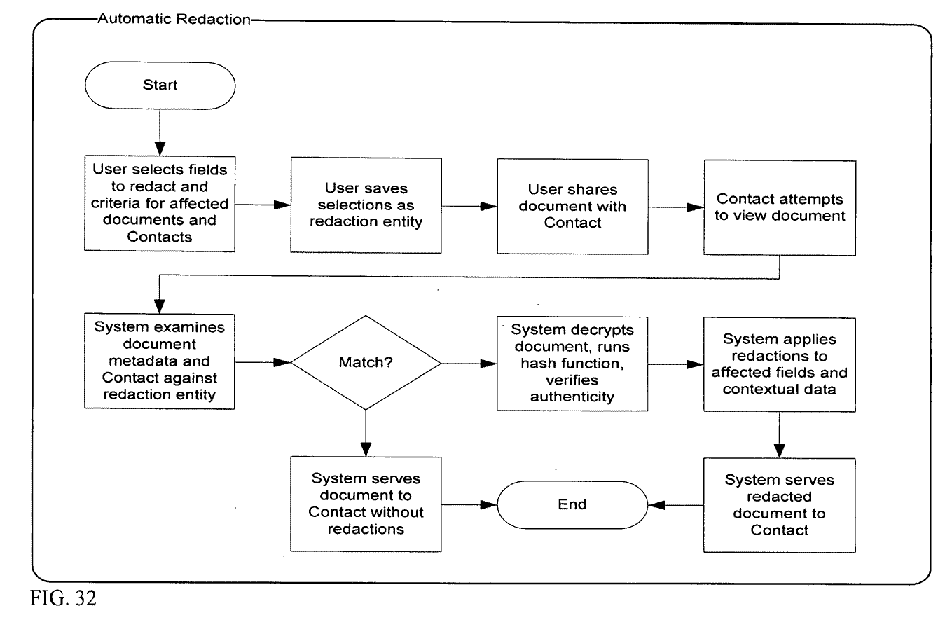

In this embodiment, an Owner can instruct the System to apply redaction to certain fields or areas on all documents, or all documents meeting certain criteria, prior to sharing. In this case, the documents have extractable contextual data associated with them. The System will perform this function as follows (see FIG. 32):

1. The System will provide an Owner with an interface that enables the Owner to select from a list of common document fields, including without limitation Address, Telephone Number, Account Number, and Social Security Number, which the Owner wants to redact.

2. The System also provides an interface, similar to the Search interface (see “Searching for Documents” discussed above), that enables the Owner to specify metadata values in order to limit redactions to documents meeting certain criteria.

3. The System also provides an interface that enables the Owner to select particular Contacts for which the Owner wants shared documents redacted.

4. The Owner saves these selections, with a name of the Owner's choosing, as a “redaction entity.” The Owner can create multiple redaction entities. The System enables the Owner to enable or disable each redaction entity.

5. The Owner shares documents as per the Basic Document Sharing embodiment (see “Basic Document Sharing” discussed above) or any of the Automatic Document Sharing embodiments (see “Automatic Document Sharing” discussed above).

6. The System notifies that Contact or Contacts that there are new shared documents available.

7. When a Contact chooses to view one of the Owner's documents, the System examines the Owner's enabled redaction entities to determine if the document meets the Owner's specified criteria for being redacted for that particular Contact.

8. If the document does not meet any of the Owner's criteria for being redacted for that particular Contact, the document is shared without redaction. Otherwise, the System decrypts the document (see “Decryption” discussed later below), then runs the hash function on the decrypted original document to verify that it has not been altered since it was acquired.

9. The System then analyzes the extractable contextual data associated with the document to determine if any of the fields selected in step 1 are present in the document.

10. If any of the selected fields is present, the System creates a copy of the document image file and associated contextual data, determines what portions of the document image file to redact, applies redaction boxes to those portions in the copy of the image file, and deletes the affected data in the copy of the contextual data.

11. The System then serves up the redacted copy of the document to the Contact.

In an alternative embodiment, the Owner would be able to select only fields to redact (as in step 1 above), and redactions would be applied to these fields in all documents shared with all Contacts.

Default Redaction

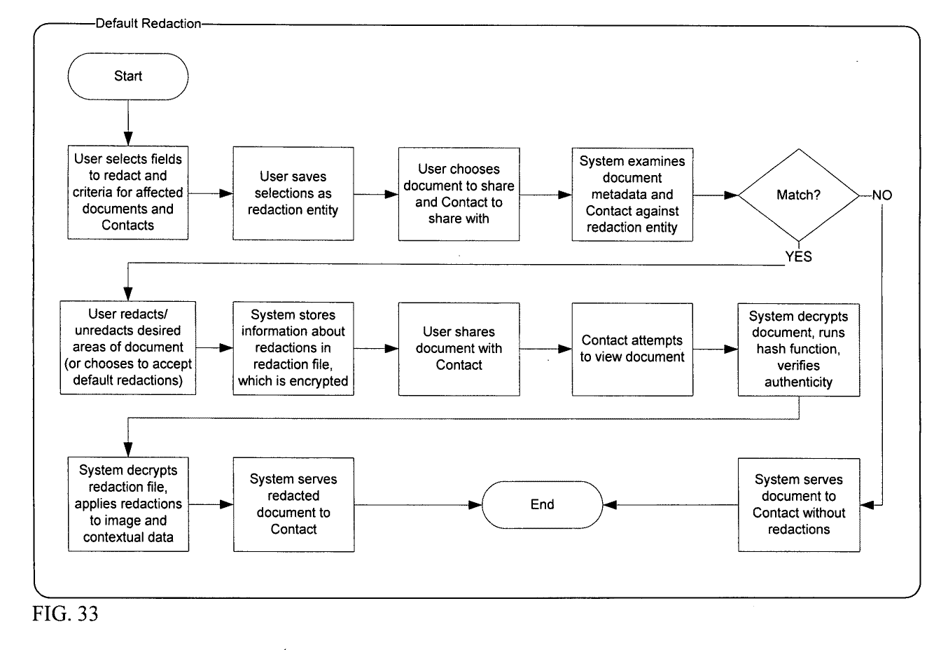

In this embodiment, an Owner can instruct the System to apply redaction, by default, to certain fields on all documents, or all documents meeting certain criteria, prior to sharing. In this case, for a given document to be shared, the Owner will have the opportunity (by clicking on affected areas of the document's image, or by some other means) to unredact one or more redacted areas, add areas to redact (as in the Manual Redaction embodiment), or both. In this case, the documents have extractable contextual data associated with them. The System will perform this function as follows (see FIG. 33):

1. The System will provide an Owner with an interface that enables the Owner to select from a list of common document fields, including without limitation Address, Telephone Number, Account Number, and Social Security Number, which the Owner wants to redact.

2. The System also provides an interface, similar to the Search interface (see “Searching for Documents” discussed above), that enables the Owner to specify metadata values in order to limit redactions to documents meeting certain criteria.

3. The Owner saves these selections, with a name of the Owner's choosing, as a “redaction entity.” The Owner can create multiple redaction entities. The System enables the Owner to enable or disable each redaction entity.

4. As part of the document sharing interface (see “Basic Document Sharing” discussed above), for each document that the Owner chooses to share, and which meets the criteria specified in step 2, the System enables the Owner to view an image of the document to be shared, with the default redactions applied.

5. The System's interface enables the Owner to unredact areas that are redacted by default (by clicking on the redacted areas, or by some other means), and to select additional portions of the document to redact (by clicking on the affected data values, or by drawing redaction boxes over the desired areas, or by some other means).

6. When the Owner is finished making redaction selections, the Owner saves the redacted image. (Alternatively, the Owner could choose to accept the default redactions without making any changes.) The System encrypts and stores information about the redacted areas and redacted contextual data in a file (called the “redaction file”) stored separately from, but associated with, the image file.

7. As in the basic document sharing embodiment, the Owner then proceeds to share the document with one or more Contacts. The System notifies that Contact or Contacts that there are new shared documents available.

8. When a Contact chooses to view the shared document, the System first decrypts the document (see “Decryption” discussed later below), then runs the hash function on the decrypted document to verify that it has not been altered since it was acquired. The System also decrypts the associated redaction file.

9. The System uses the information in the redaction file to apply redactions to appropriate areas of the image, and to delete the extractable contextual data associated with those areas.

10. The system then serves up the redacted copy of the document to the Contact. (In another embodiment, the System would run a second hash function on the redacted image of the document, so as to indicate to the Contact which parts of the redacted document were altered by the redaction process.)

Manual Redaction, No Contextual Data

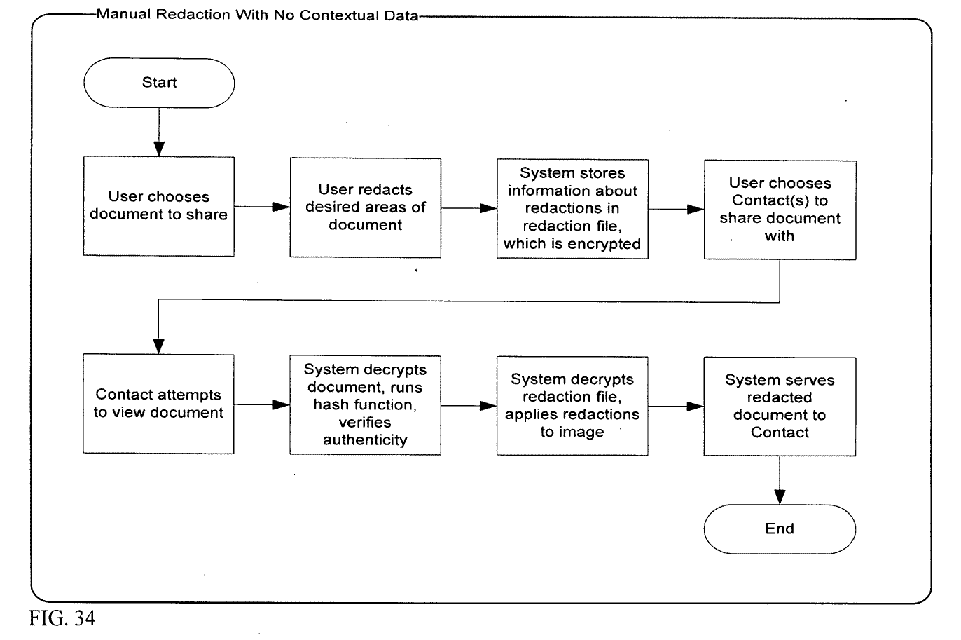

In this embodiment, prior to sharing a particular document, the Owner can use an interface that enables a user to select, on the document's image, portions of a document to redact. In this case, the document has no extractable contextual data associated with it. The System will perform this function as follows (see FIG. 34):

1. As part of the document sharing interface (see “Basic Document Sharing” discussed above), the System enables an Owner to view, for purposes of redaction, the image of a document to be shared.

2. The System's interface enables the Owner to select, on the document's image, the portions of the document to redact (by drawing redaction boxes over the desired areas, or by some other means).

3. When the Owner is finished making redaction selections, the Owner saves the redacted image. The System encrypts and stores information about the redacted areas and in a file (called the “redaction file”) stored separately from, but associated with, the image file.

4. As in the basic document sharing embodiment, the Owner then proceeds to share the document with one or more Contacts. The System notifies that Contact or Contacts that there are new shared documents available.

5. When a Contact chooses to view the shared document, the System first decrypts the document (see “Decryption” discussed later below), then runs the hash function on the decrypted document to verify that it has not been altered since it was acquired. The System also decrypts the associated redaction file.

6. The System uses the information in the redaction file to apply redactions to appropriate areas of the image.

7. The system then serves up the redacted copy of the document to the Contact. (In another embodiment, the System would run a second hash function on the redacted image of the document, so as to indicate to the Contact which parts of the redacted document were altered by the redaction process.)

Document-Class Redaction

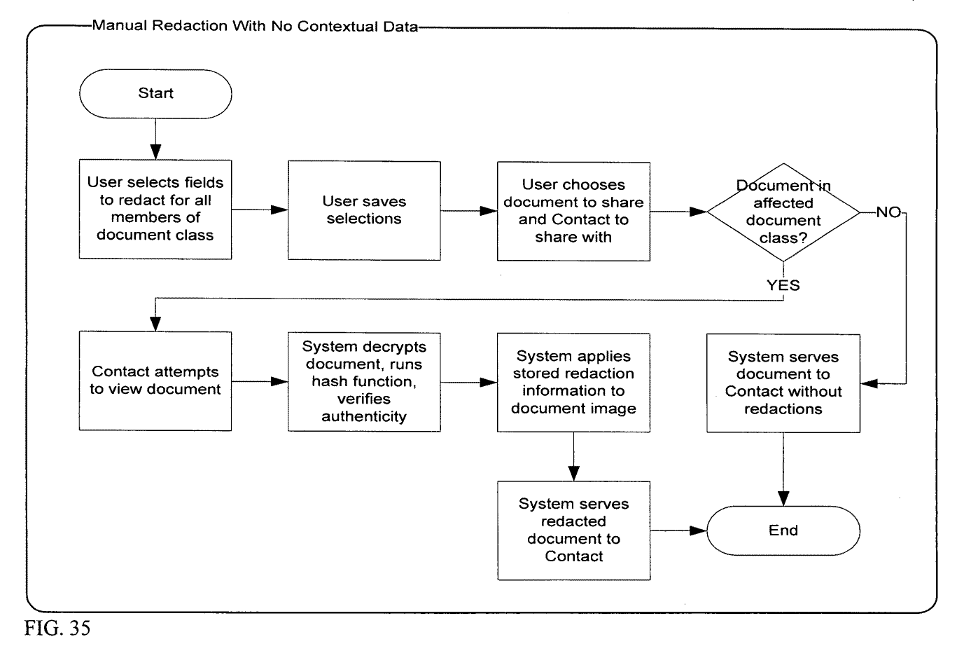

In this embodiment, an Owner could instruct the System to redact certain areas of all documents of a given document class (“document class” being defined here as a specific document type from a given financial institution; for example, statements from a given brokerage, or cancelled checks from a given bank) or all documents of a given document class meeting certain criteria. In this case, the documents do not have any extractable contextual data associated with them. The System would perform this function as follows (see FIG. 35):

1. The System will supply an interface that enables the user to select, on an image of a representative document from a document class, those areas to redact (by drawing redaction boxes over the desired areas, or by some other means).

2. The System stores the geometric information (position and dimensions) for the redaction boxes.

3. As in the basic document sharing embodiment (see “Basic Document Sharing” discussed above), the Owner then proceeds to share a document from that document class with one or more Contacts.

4. The System notifies that Contact or Contacts that there are new shared documents available.

5. When a Contact chooses to view the shared document, the system first decrypts the document (see “Decryption” discussed later below), then runs the hash function on the decrypted document to verify that it has not been altered since it was acquired.

6. The System uses the stored redaction information file to apply redactions to appropriate areas of the image.

7. The system then serves up the redacted copy of the document to the Contact. (In another embodiment, the System would run a second hash function on the redacted image of the document, so as to indicate to the Contact which parts of the redacted document were altered by the redaction process.)

Default Redaction Per Document Class

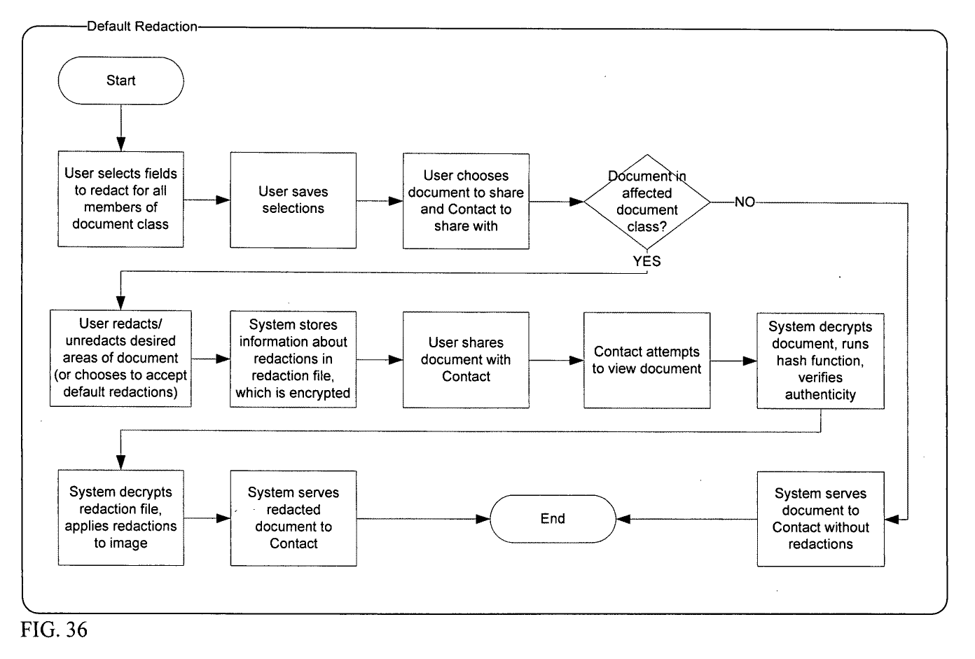

This embodiment is similar to the Document-class Redaction embodiment, except that for a given document in a document class to be shared, the System would give the Owner the opportunity to unredact one or more redacted areas, add areas to redact (as in the Manual Redaction embodiment), or both. In this case, the documents have no extractable contextual data associated with them. The System would perform this function as follows (see FIG. 36):

1. The System will supply an interface that enables the user to select, on an image of a representative document from a document class, those areas to redact (by drawing redaction boxes over the desired areas, or by some other means).

2. The System stores the geometric information (position and dimensions) for the redaction boxes.

3. As in the basic document sharing embodiment (see “Basic Document Sharing” discussed above), the Owner then proceeds to share a document from that document class with one or more Contacts. For each document in that document class to be shared, the System enables the Owner to view an image of the document to be shared, with the default redactions applied.

4. The System's interface enables the Owner to unredact areas that are redacted by default (by clicking on the redacted areas, or by some other means), and to select additional portions of the document to redact (by drawing redaction boxes over the desired areas, or by some other means).

5. When the Owner is finished making redaction selections, the Owner saves the redacted image. (Alternatively, the Owner could choose to accept the default redactions without making any changes.) The System encrypts and stores information about the redacted areas in a file (called the “redaction file”) stored separately from, but associated with, the image file.

6. As in the basic document sharing embodiment, the Owner then proceeds to share the document with one or more Contacts. The System notifies that Contact or Contacts that there are new shared documents available.

7. When a Contact chooses to view the shared document, the System first decrypts the document (see “Decryption” discussed later below), then runs the hash function on the decrypted document to verify that it has not been altered since it was acquired. The System also decrypts the associated redaction file.

8. The System uses the information in the redaction file to apply redactions to appropriate areas of the image.

9. The system then serves up the redacted copy of the document to the Contact. (In another embodiment, the System would run a second hash function on the redacted image of the document, so as to indicate to the Contact which parts of the redacted document were altered by the redaction process.)

Other Document Sharing Embodiments

In another embodiment, the System would allow the Owner to revoke shared documents, which causes the System to discontinue the availability of the document to the Contact.

Ownership Transfer

Document Ownership Transfer

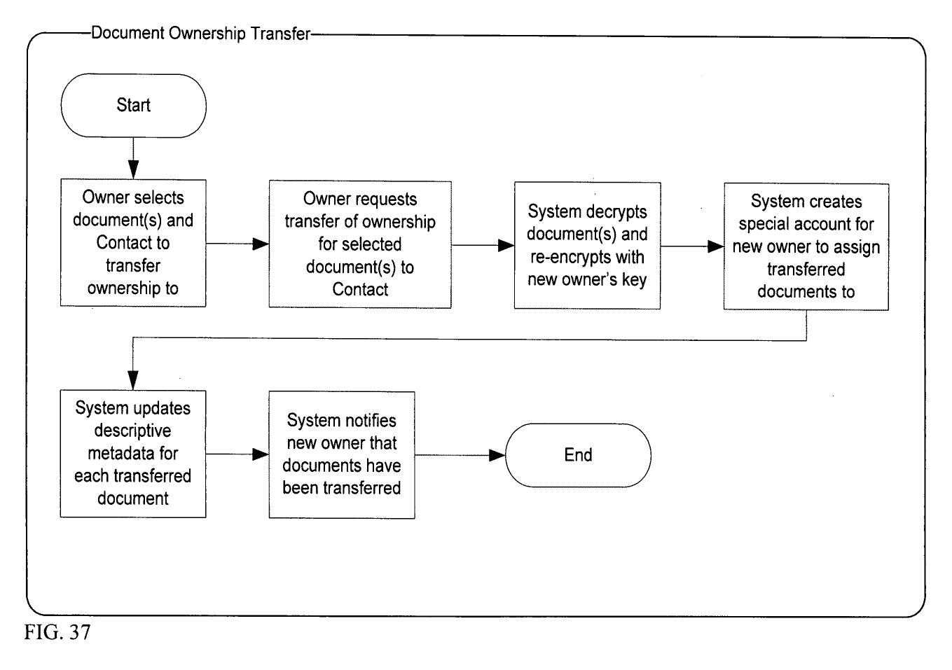

In another embodiment, the System would enable the Owner to transfer full ownership rights for a given document to another user. The System would perform this function as follows (see FIG. 37):

1. In a manner similar to the Basic Document Sharing embodiment (see “Basic Document Sharing” discussed above), the Owner selects one or more documents that he or she wants to transfer ownership of, and one Contact to transfer ownership to (in this embodiment, a document can have one and only one Owner at one time).

2. The Owner then requests that ownership of the selected documents be transferred to the selected Contact. (In another embodiment, the System then verifies that the Owner really wants to take this action.)

3. The System decrypts each document (see “Decryption”), then re-encrypts each document using the new Owner's key (see “Encryption” discussed later below).

4. The System creates a special Account for the new Owner for documents whose ownership has been transferred to the new Owner, in a manner similar to creating an account for an unsupported Source (see “Account Creation for Unsupported Sources” discussed above). In this embodiment, a document must be associated with an Account.

5. The System updates the descriptive metadata associated with the document or documents to indicate the new Owner and new Account.

6. The system notifies the new Owner by email that the previous Owner has transferred ownership of one or more documents to the new Owner. In an alternative embodiment, the System notifies the new Owner the next time the new Owner logs into the System.

Account Ownership Transfer

In another embodiment, the System would enable the Owner to transfer full ownership rights for all documents in an Account to another user. The System would perform this function as follows:

1. If the recipient has not already done so, the recipient sets up the financial institution in his or her System account (see “Source Management” discussed above).

2. The System provides an interface in which the original Owner can manage Accounts. This interface enables the Owner to select an Account to transfer, and a Contact to whom to transfer the Account.

3. The Owner then requests that ownership of the documents in the Account be transferred to the selected Contact. (In another embodiment, the System then verifies that the Owner really wants to take this action.)

4. The System decrypts each document (see “Decryption” discussed later below), then re-encrypts each document using the new Owner's key (see “Encryption” discussed later below).

5. The System creates an Account for the new Owner, and associates this account with the financial institution that the new Owner set up in step 1.

6. The System updates the descriptive metadata associated with the documents to indicate the new Owner and new Account.

7. The system notifies the new Owner by email that the previous Owner has transferred ownership of one or more documents to the new Owner. In an alternative embodiment, the System notifies the new Owner the next time the new Owner logs into the System.

Document Authenticity Evidence Process

The disclosed invention collects and/or creates evidence that various users can review to judge whether they believe particular Digital Documents are authentic. The Digital Document Authenticity Evidence process works as follows:

1. The System either collects a Digital Document from a Source or in an alternative embodiment a Digital Document is uploaded or sent by a Source into the System. The System performs a hash function on that Digital Document after it has been encrypted. For more information about encryption, see “Encryption” discussed below.

2. For purposes of document authenticity evidence (i.e., in addition to other document metadata not related to authenticity), the System associates and stores the following with a particular Digital Document: (a) Its hash result; its Source's name; and (c) its Acquisition Date.

3. Before serving the document up to a user, the System runs a hash function on that particular Digital Document.

4. The System compares the hash to the hash stored at acquisition time to ensure the Digital Document has not been altered since its Acquisition Date.

5. If the Digital Document has not been altered, the System serves the requested Digital Document up to the user for viewing with an indication that that Digital Document's integrity has been verified. If the Digital Document was altered, the System notifies the Contact with an error message indicating that the Document was altered.

6. The System also presents to the user that Digital Document's Source's name and the Acquisition Date.

In an alternative embodiment, the System presents the metadata used for Authenticity Evidence only to users who have directly or indirectly paid an additional fee. For example without limitation, the user could directly pay an additional fee per document access, or an annual fee to cover all document accesses; or, the user could have the per-document-access fee paid by the Owner.

Storage

Document Storage

Encrypted document image files are stored on a secure central file server, with a file name that does not reveal any information about the document (such as the Owner, the document type, financial institution, and so on). If there is contextual data associated with a document image file but located in a separate file, the encrypted contextual data file is also stored on the secure central file server. The location of each file (image and contextual data) is stored in the metadata database as part of the metadata for that document. In an alternative embodiment, an Owner's encrypted document image files would be stored on that Owner's local computer.

Metadata Storage

The metadata for all documents is stored in a database on a secure central server. In an alternative embodiment, the document image file, contextual data (if any), associated metadata, and authenticity evidence information could be stored together in a single file, of a proprietary file type that can be read and written only by the System.

Privacy and Security

The disclosed System's storage and encryption architecture is designed to protect the security of users' stored financial institution credentials, documents, and the information contained within those documents.

Security Architecture

The System stores encrypted documents and users' keys in separate partitions in the data storage server. (In another embodiment, the documents and keys could be stored on separate physical machines.) The System Master Key, which is used to encrypt and decrypt users' keys, is stored in encrypted form in a peripheral media device, such as a USB flash memory drive or memory card. An operator who is starting up the Application Server (which handles encryption and decryption of documents, among other tasks) must decrypt the System Master Key and load it into the Application Server's memory. The peripheral media device is the only nonvolatile storage device upon which any form of the System Master Key resides, and the System Master Key is changed on a regular schedule. All communications between the user's Web browser and the Application Server are conducted over a secure (SSL) connection. All System servers are protected by a secure firewall. The system network architecture, including all routers and switches, is designed to prevent unauthorized access to the System. System access is logged and the logs can be analyzed for suspicious activity. In another embodiment, a separate server would handle the encryption and decryption tasks, and the Application Server would take incoming requests and serve decrypted documents to users. Every encryption and decryption transaction is logged. The logs can be analyzed for suspicious behavior.

Encryption

Digital Documents are encrypted after any metadata has been extracted from the Digital Documents (see “Descriptive Metadata Acquisition” discussed above). Documents are encrypted using an encryption key that is unique to each user (in other embodiments, keys could also be unique to each document or each account). The encryption component retrieves the appropriate key from the encryption key store, decrypts the key with the System Master Key, and encrypts the document. Once the document is encrypted the key is discarded by the encryption component and the encrypted document is stored the document storage.

Before a Digital Document is encrypted and stored, the System runs the hash function on the document. After the encrypted document is stored, a background process periodically decrypts it, loads the decrypted document into the System's memory, runs the hash function on the decrypted document, and compares the hash result with the hash result that was calculated at acquisition. This process verifies that the document has not inadvertently been altered due to data loss or data corruption. In an alternative embodiment, the System runs the hash function on the document after it is encrypted. In this case, a background process can periodically confirm that the document has not inadvertently been altered due to data loss or corruption without needing to decrypt the document each time.

The document cannot be decrypted without the System master key, the key store access account and the user's AES key working in concert. By requiring three different levels of security access to decrypt any document, the System makes it very difficult if not practically impossible for any single individual (even an insider) other than the users to gain access to that user's Digital Documents.

Decryption

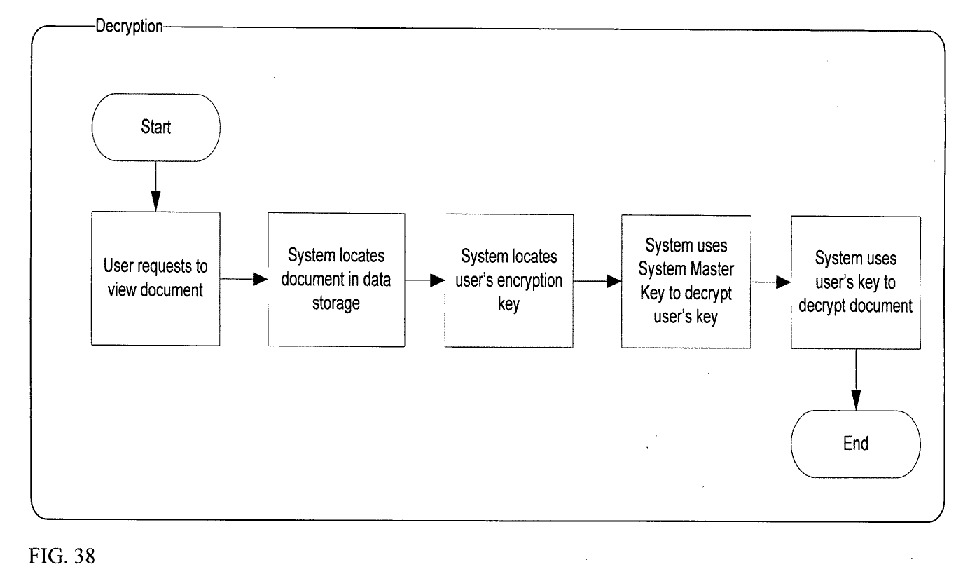

The sequence of actions required to decrypt an Acquired Document is as follows (see FIG. 38):

1. The application server receives a request over a secure connection from the user's web browser to view an encrypted document. The document identification is encoded in the request URL and would have been generated by a previous operation and presented to the user on a web page.

2. The application server locates the user's account information using session data provided by the browser and using the database, the application server retrieves the location of the document referenced in the request URL. The application server can now access the user's document in the file store but it is still in an encrypted state.

3. The document must be decrypted using the user's personal encryption key that was generated when they first registered with the service. This key is stored in the key store database, encrypted using the System master key. In another embodiment, the key store database would be further encrypted by a database encryption scheme.

4. The application server now securely connects to the key store database and asks the database to decrypt and return the user's personal encryption key. When the application server receives the key from the database it is still encrypted and must be further decrypted using the System master key.

5. With the user's personal key now fully decrypted, the application server can decrypt the document file and securely pass it back to the user's browser for further viewing and manipulation. The application server then discards the user's decrypted key and logs the transaction for auditing purposes.

Persistent Control of Rights to a Shared Document

In another embodiment, the System would enable to Owner, or a System administrator, to grant and revoke other sharing rights including, without limitation, the abilities to:

1. Print particular documents

2. Export particular documents

3. Share particular documents with other users

4. Access the document authenticity evidence

5. Access certain descriptive metadata

In another embodiment, the System would enable the Owner, or a System administrator, to grant certain rights for pre-specified time periods. For example, a Contact may be able to view a document for one month but would be able to print it out for only one day. The Owner would be able to modify the time periods to either revoke certain rights or to extend certain rights.

Integration with Other Hardware, Networks, and Software Programs

By integrating with other programs, the System would be able to automatically collect or pass on the following with respect to one or more documents: Authenticity Evidence, Integrity Evidence, Contextual Data, Administrative Metadata, Structural Metadata, and/or Descriptive Metadata. Furthermore, the system would empower the Owner to control which users of such other programs would get access to a particular Digital Document or Acquired File. The system could also empower the Owner to determine which users can access which information related to a particular document.

The System's integration would include: 1) a secure means of communicating; 2) a way to pass data, the Acquired File, Administrative data, and/or Digital Documents from the system to a particular software program. The System's integration would include the use of one or more common libraries or definitions for: 1) Contextual Data, 2) Administrative Metadata, 3) Structural Metadata, 4) Descriptive Metadata, 5) Integrity Evidence, and/or 6) Authenticity Evidence.

The System can be integrated with other hardware, networks, and software implemented processes that provide:

1. Tax preparation
a. By consumer
b. By professional preparer

2. Accounting
a. Budgeting, Cash Flow Tracking
   i. Consumer
   ii. Business
b. Expense reports or Project costs estimates

3. Investing
a. Tracking Net Worth
b. Asset allocation
c. Rate of return comparison
d. Cost basis tracking
e. Expense tracking
f. Volatility analysis
g. Correlation analysis
h. Monte Carlo Analysis

4. Loan Applications
a. Mortgage
b. Student
c. Car
d. Business
e. Other

5. Grant Applications
a. Pell Grants

6. Bill payment
a. Online banking bill pay

7. Audit Systems

8. SEC system
a. Annual reports and other statements
b. Proxy voting

9. Enterprise document or record management systems

10. Insurance
a. House
b. Car

11. Medical
a. Insurance
b. Prescriptions
c. Test results
d. Doctor's notes
e. Diagnosis
f. Treatment info

12. Identity verification
a. Something you are
   i. Fingerprint
   ii. Typing style
   iii. Voice recognition
   iv. Face recognition
b. Something you know
   i. User name and password
   ii. Partial password usage
c. Something you have
   i. USB Token
   ii. Identity card
   iii. Out-of-band communication to or from a second device (such as a mobile phone)

Examples of the kinds of software implemented process described above include: Quicken, Money, TurboTax, Yodleee, QuickBooks, Gains Keeper, CC&H, Authernative and Great Plains.

The process and system of the present invention has been described above in terms of functional modules. It is understood that unless otherwise stated to the contrary herein, one or more functions may be integrated in a single physical device or a software module in a software product, or a function may be implemented in separate physical devices or software modules, without departing from the scope and spirit of the present invention. It will be further appreciated that the line between hardware, firmware and software is not always sharp.

It is appreciated that detailed discussion of the actual implementation of each step that comprises the process is not necessary for an enabling understanding of the invention. The actual implementation is well within the routine skill of a programmer and computer engineer, given the disclosure herein of the system attributes, functionality and inter-relationship of the various software and hardware components in the system. A person skilled in the art, applying ordinary skill can practice the present invention without undue experimentation.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

1. A system for document acquisition, comprising:
a user device communicating with a network;
a network-based application accessible to the user, wherein the network-based application is structured and configured to automatically: a) collect Digital Documents, b) create standardized descriptive metadata related to each Digital Document, c) use that descriptive metadata to organize, sort, and filter the collected Digital Documents, d) collect and create evidence that third party users can use to judge the authenticity of particular Digital Documents, e) protect the users privacy during the collection, storage, and sharing of the Digital Documents.

2. A system for document acquisition as in claim 1, wherein the network-based application comprises a web-based application that is structured and configured to provide a user with functionalities including user management, Source management, automatic and manual document acquisition, and document management and sharing.

3. A system for document acquisition as in claim 1, wherein the network-based application is further structured and configured to receive Digital Documents that users manually upload into it.

4. A system for document acquisition as in claim 3, wherein the network-based application is further structured and configured to enable a user to manually enter standardized descriptive metadata.
